(19) United States
(12) Patent Application Publication
(10) Pub. No.: US 2023/0314167 A1
(43) Pub. Date: Oct. 5, 2023

(54) METHOD AND APPARATUS FOR GENERATING MAP DATA, AND NON-TRANSITORY COMPUTER-READABLE STORAGE MEDIUM

(71) Applicant: TOYOTA JIDOSHA KABUSHIKI KAISHA, Toyota-shi (JP)

(72) Inventors: Keisuke HOKAI, Gotemba-shi (JP); Taichi KAWANAI, Susono-shi (JP)

(73) Assignee: TOYOTA JIDOSHA KABUSHIKI KAISHA, Toyota-shi (JP)

(21) Appl. No.: 18/164,299

(22) Filed: Feb. 3, 2023

(30) Foreign Application Priority Data
Mar. 15, 2022 (JP) 2022-040162

(51) Int. Cl. G01C 21/00; G01C 21/32

(52) U.S. Cl. CPC G01C 21/3833; G01C 21/32

(57) ABSTRACT

According to the method of the present disclosure, first, a plurality of data sets is generated from a travel log data group. Each of the plurality of data sets includes one or more travel log data. Each travel log data is defined by one or more parameters. Next, map data for evaluation is generated from each of the plurality of data sets. Then, an evaluation value is calculated for each map data for evaluation. Then, a relationship between a combination of conditions of the one or more parameters and the evaluation value is specified based on a correspondence relationship between each of the plurality of data sets and the evaluation value of each map data for evaluation. And finally, map data for autonomous driving in which the evaluation value is associated with each combination of conditions of the one or more parameters is generated.

### CROSS-REFERENCE TO RELATED APPLICATION

The present application claims priority under 35 U.S.C. §119 to Japanese Patent Application No. 2022-040162, filed Mar. 15, 2022, the disclosure of which is incorporated herein by reference in the entirety.

### BACKGROUND

### Field

The present disclosure relates to a technique for generating map data for autonomous driving.

### Background Art

JP2020-076726A discloses a map information system. Map information used in the map information system is associated with an evaluation value indicating the likelihood of the map information for each location in an absolute coordinate system. The map information system acquires an evaluation value for each point or section within a target range in which a vehicle travels based on the map information. Then, the map information system determines an allowable level of driving assistance control for each point or section within the target range based on the evaluation value and the location at which an intervention operation is performed by a driver.

In the prior art described above, the allowable level of the driving assistance control is determined by uniformly giving the evaluation value to the map information. However, the conditions of parameters such as the internal state of the system, such as the state of sensors, and the external state of the system, including weather and time, change dynamically. Therefore, it is difficult to determine the allowable level of the driving assistance control in the current state based on the uniform evaluation value given in advance. This also applies to a case where the map information to which the evaluation value is given is used in the autonomous driving.

In addition to the above-described JP2020-076726A, JP2021-076593A, JP2019-203823A, and JP2020-038361A can be exemplified as documents showing the technical level of the technical field related to the present disclosure.

### SUMMARY

The present disclosure has been made in view of the above-described problem, and an object thereof is to provide a technique capable of coping with a dynamic change in a condition of a parameter related to autonomous driving during autonomous driving based on map data.

The present disclosure provides, as a map data generation technique, a map data generation method, a map data generation apparatus, and a map data generation program.

The map data generation method of the present disclosure comprises the following steps. The first step is to generate a plurality of data sets from a travel log data group. Each of the plurality of data sets includes one or more travel log data. Each travel log data included in the travel log data group is defined by one or more parameters. The second step is to generate map data for evaluation from each of the plurality of data sets. The third step is to calculate an evaluation value for each map data for evaluation generated from each of the plurality of data sets. The fourth step is to specify, based on a correspondence relationship between each of the plurality of data sets and the evaluation value of each map data for evaluation, a relationship between a combination of conditions of the one or more parameters and the evaluation value. The fifth step is to generate map data for autonomous driving in which the evaluation value is associated with each combination of conditions of the one or more parameters.

A map data generation apparatus of the present disclosure comprises at least one processor and at least one program memory coupled to the at least one processor. The at least one program memory stores a plurality of executable instructions. The plurality of executable instructions is configured to cause the at least one processor to execute the following processes. The first process is to generate a plurality of data sets from a travel log data group. Each of the plurality of data sets includes one or more travel log data. Each travel log data included in the travel log data group is defined by one or more parameters. The second process is to generate map data for evaluation from each of the plurality of data sets. The third process is to calculate an evaluation value for each map data for evaluation generated from each of the plurality of data sets. The fourth process is to specify, based on a correspondence relationship between each of the plurality of data sets and the evaluation value of each map data for evaluation, a relationship between a combination of conditions of the one or more parameters and the evaluation value. The fifth process is to generate map data for autonomous driving in which the evaluation value is associated with each group of conditions of the one or more parameters.

A map data generation program according to the present disclosure is configured to cause a computer to execute the following processes. The first process is to generate a plurality of data sets from a travel log data group. Each of the plurality of data sets includes one or more travel log data. Each travel log data included in the travel log data group is defined by one or more parameters. The second process is to generate map data for evaluation from each of the plurality of data sets. The third process is to calculate an evaluation value for each map data for evaluation generated from each of the plurality of data sets. The fourth process is to specify, based on a correspondence relationship between each of the plurality of data sets and the evaluation value of each map data for evaluation, a relationship between a combination of conditions of the one or more parameters and the evaluation value. The fifth process is to generate map data for autonomous driving in which the evaluation value is associated with each group of conditions of the one or more parameters. The map data generation program of the present disclosure may be recorded in a non-transitory computer-readable storage medium or may be provided via a network.

According to the map data generation technique of the present disclosure, map data associated with an evaluation value for each combination of conditions of one or more parameters that define travel log data is generated. By using such map data for autonomous driving, the autonomous driving vehicle can determine the vehicle behavior by drawing from the map data the condition of the current parameter related to autonomous driving and the evaluation value corresponding thereto. That is, according to the map data generation technique of the present disclosure, during autonomous driving based on map data, map data capable of coping with a dynamic change in a condition of a parameter related to autonomous driving is generated.

In the map data generation technique of the present disclosure, the one or more parameters may include a parameter representing an internal state of the autonomous driving vehicle or may include a parameter representing an external state of the autonomous driving vehicle. By inclusion of the parameter representing the internal state, it is possible to enable the vehicle behavior to cope with a change in the internal state during autonomous driving using map data. By inclusion of the parameter representing the external state, it is possible to enable the vehicle behavior to cope with a change in the external state during autonomous driving using map data.

In the map data generation technique of the present disclosure, the calculating the evaluation value may comprise calculating a relative evaluation value based on a relative evaluation between the map data for evaluation. Also, the calculating the evaluation value may comprise calculating an absolute evaluation value based on a defined absolute criterion.

In addition, the present disclosure provides a travel plan creation technique using the map data generated by the above-described map data generation technique, that is, a travel plan creation method, a travel plan creation apparatus, and a travel plan creation program.

The travel plan creation method of the present disclosure comprises the following steps. The first step is to acquire map data for autonomous driving generated by the map data generation technique described above. The second step is to acquire a condition of the one or more parameters in the autonomous driving vehicle. The third step is to acquire an evaluation value corresponding to the condition of the one or more parameters in the autonomous driving vehicle from the map data for autonomous driving. The fourth step is to create a travel plan of the autonomous driving vehicle based on the evaluation value acquired from the map data for autonomous driving.

A travel plan creation apparatus of the present disclosure comprises at least one processor and at least one program memory coupled to the at least one processor. The at least one program memory stores a plurality of executable instructions. The plurality of executable instructions is configured to cause the at least one processor to execute the following processes. The first process is to acquire map data for autonomous driving generated by the map data generation technique described above. The second process is to acquire a condition of the one or more parameters in the autonomous driving vehicle. The third process is to acquire an evaluation value corresponding to the condition of the one or more parameters in the autonomous driving vehicle from the map data for autonomous driving. The fourth process is to create a travel plan of the autonomous driving vehicle based on the evaluation value acquired from the map data for autonomous driving.

A travel plan creation program according to the present disclosure is configured to cause a computer to execute the following processes. The first process is to acquire map data for autonomous driving generated by the map data generation technique described above. The second process is to acquire a condition of the one or more parameters in the autonomous driving vehicle. The third process is to acquire an evaluation value corresponding to the condition of the one or more parameters in the autonomous driving vehicle from the map data for autonomous driving. The fourth process is to create a travel plan of the autonomous driving vehicle based on the evaluation value acquired from the map data for autonomous driving. The travel plan creation program of the present disclosure may be recorded in a non-transitory computer-readable storage medium or may be provided via a network.

According to the travel plan creation technique of the present disclosure, since the map data generated by the above-described map data generation technique is used for creation of a travel plan, the travel plan is created so as to be able to cope with a dynamic change in a condition of a parameter related to autonomous driving.

In the travel plan creation technique of the present disclosure, creating the travel plan may comprise selecting whether to continue or stop autonomous driving in accordance with the evaluation value. The creating the travel plan may comprise selecting a travel mode appropriate for the evaluation value. Further, the creating the travel plan may comprise selecting a route appropriate for the evaluation value.

As described above, according to the map data generation technique of the present disclosure, during autonomous driving based on map data, map data capable of coping with a dynamic change in a condition of a parameter related to autonomous driving is generated. Further, according to the travel plan creation technique of the present disclosure, by using the map data generated by the map data generation technique of the present disclosure, a travel plan is created so as to cope with a dynamic change in a condition of a parameter related to autonomous driving.

### BRIEF DESCRIPTION OF THE DRAWINGS

FIG. 1 is a conceptual diagram for explaining a problem of autonomous driving based on map data.

FIG. 2 is a conceptual diagram for explaining means for solving the problem explained in FIG. 1, and is a conceptual diagram for explaining an outline of a map data generation method according to an embodiment of the present disclosure.

FIG. 3 is a block diagram illustrating functions of a map data generation apparatus and an autonomous driving ECU according to the embodiment of the present disclosure.

FIG. 4 is a block diagram illustrating an example of a hardware configuration of the map data generation apparatus according to the embodiment of the present disclosure.

FIG. 5 is a block diagram illustrating an example of a hardware configuration of the autonomous driving ECU according to the embodiment of the present disclosure.

FIG. 6 is a conceptual diagram for explaining the map data generation method executed by the map data generation apparatus according to the embodiment of the present disclosure, and is a conceptual diagram illustrating an example of a configuration of a travel log data database.

FIG. 7 is a conceptual diagram for explaining the map data generation method executed by the map data generation apparatus according to the embodiment of the present disclosure, and is a conceptual diagram for explaining log data combination generation processing.

FIG. 8 is a conceptual diagram for explaining the map data generation method executed by the map data generation apparatus according to the embodiment of the present disclosure, and is a conceptual diagram for explaining map data generation processing.

FIG. 9 is a conceptual diagram for explaining the map data generation method executed by the map data generation apparatus according to the embodiment of the present disclosure, and is a conceptual diagram for explaining map data evaluation processing and parameter evaluation processing.

FIG. 10 is a diagram illustrating another calculation example of the map data by the map data generation processing.

FIG. 11 is a diagram illustrating another calculation example of the map data evaluation value and the parameter evaluation value by the map data evaluation processing and the parameter evaluation processing.

FIG. 12 is a diagram for explaining the map data generation method executed by the map data generation apparatus according to the embodiment of the present disclosure, and is a conceptual diagram for explaining autonomous driving map data registered in a map data database.

FIG. 13 is a conceptual diagram for explaining an example of a format of travel log data stored in a travel log data database.

FIG. 14 is a conceptual diagram for explaining an example of a combination of travel log data in the log data combination generation processing.

FIG. 15 is a conceptual diagram for explaining an example of a correspondence relationship between a combination of conditions of a plurality of parameters and an evaluation value in the parameter evaluation processing.

FIG. 16 is a conceptual diagram for explaining a specific example of the map data evaluation processing by the map data generation apparatus according to the embodiment of the present disclosure, and is a conceptual diagram for explaining an example of self-location estimation at a pose by SLAM.

FIG. 17 is a conceptual diagram for explaining a specific example of the map data evaluation processing by the map data generation apparatus according to the embodiment of the present disclosure, and is a conceptual diagram for explaining an example of success of the self-location estimation at the pose by SLAM.

FIG. 18 is a conceptual diagram for explaining a specific example of the map data evaluation processing by the map data generation apparatus according to the embodiment of the present disclosure, and is a conceptual diagram for explaining an example of failure of the self-location estimation at the pose by SLAM.

FIG. 19A and FIG. 19B are conceptual diagrams for explaining a specific example of the map data evaluation processing by the map data generation apparatus according to the embodiment of the present disclosure, and are conceptual diagrams for explaining a p-value as the evaluation value.

FIG. 20 is a conceptual diagram for explaining a specific example of the map data evaluation processing by the map data generation apparatus according to the embodiment of the present disclosure, and is a conceptual diagram for explaining an example of the evaluation value using the p-value.

FIG. 21 is a conceptual diagram for explaining a specific example of the map data evaluation processing by the map data generation apparatus according to the embodiment of the present disclosure, and is a conceptual diagram for explaining an example of the evaluation value using the p-value.

FIG. 22 is a conceptual diagram for explaining a specific example of the map data evaluation processing by the map data generation apparatus according to the embodiment of the present disclosure, and is a conceptual diagram for explaining a standard deviation as the evaluation value.

FIG. 23A and FIG. 23B are conceptual diagrams for explaining a specific example of the map data evaluation processing by the map data generation apparatus according to the embodiment of the present disclosure, and are conceptual diagrams for explaining influence of accuracy of road surface shape on object detection.

FIG. 24 is a conceptual diagram for explaining a specific example of the map data evaluation processing by the map data generation apparatus according to the embodiment of the present disclosure, and is a conceptual diagram for explaining variance as the evaluation value.

FIG. 25 is a conceptual diagram for explaining a specific example of travel plan creation processing by the autonomous driving ECU according to the embodiment of the present disclosure, and is a conceptual diagram illustrating one utilization example of the evaluation value in creation of a travel plan.

FIG. 26 is a flowchart illustrating processing executed by the autonomous driving ECU according to the embodiment of the present disclosure, and is a flowchart illustrating processing for realizing the utilization example illustrated in FIG. 25.

FIG. 27 is a conceptual diagram for explaining a specific example of the travel plan creation processing by the autonomous driving ECU according to the embodiment of the present disclosure, and is a conceptual diagram illustrating another utilization example of the evaluation value in creation of a travel plan.

FIG. 28 is a flowchart showing processing executed by the autonomous driving ECU according to the embodiment of the present disclosure, and is a flowchart showing processing for realizing the utilization example shown in FIG. 27.

FIG. 29 is a conceptual diagram for explaining a specific example of the travel plan creation processing by the autonomous driving ECU according to the embodiment of the present disclosure, and is a conceptual diagram illustrating still another utilization example of the evaluation value in creation of a travel plan.

FIG. 30 is a flowchart showing processing executed by the autonomous driving ECU according to the embodiment of the present disclosure, and is a flowchart showing processing for realizing the utilization example shown in FIG. 29.

FIG. 31A and FIG. 31B are diagrams illustrating an example of vehicle control based on a comparison between a p-value associated with map data and an evaluation value calculated online.

FIG. 32A and FIG. 32B are diagrams illustrating an example of vehicle control based on a comparison between a p-value associated with map data and an evaluation value calculated online.

FIG. 33A and FIG. 33B are diagrams illustrating an example of vehicle control based on a comparison between a p-value associated with map data and an evaluation value calculated online.

### DETAILED DESCRIPTION

Hereinafter, an embodiment of the present disclosure will be described with reference to the drawings. However, in the embodiment described below, when a numerical value such as the number, quantity, amount, range, or the like of each element is mentioned, the idea according to the present disclosure is not limited to the mentioned numerical value except for a case where the numerical value is clearly specified in particular or a case where the numerical value is obviously specified to the numerical value in principle. In addition, a structure or the like described in the following embodiment is not always necessary to the idea according to the present disclosure except for a case where the structure or the like is clearly specified in particular or a case where the structure or the like is obviously specified in principle.

### 1. Outline of Map Data Generation Method

The map data in the present embodiment means data constituting a map for autonomous driving by an autonomous driving vehicle, such as a feature map, a road surface shape map (terrain map), a road surface luminance map (intensity map), and a stationary obstacle map (background knowledge). The feature map is typically used for self-location estimation of the autonomous driving vehicle. The road surface shape map is a map in which the shape (height) of the road surface in an area where the autonomous driving vehicle travels is recorded in cells. The road surface luminance map is a map in which the luminance of the road surface in the area where the autonomous driving vehicle travels is recorded in cells. The stationary obstacle map is a map in which stationary obstacles such as road structures are recorded in voxels.

To create map data, a large number of travel log data acquired by actually driving a vehicle with a sensor are used. The entire set of travel log data used to create map data is referred to as a travel log data group. Further, the travel log data may be abbreviated as log data.

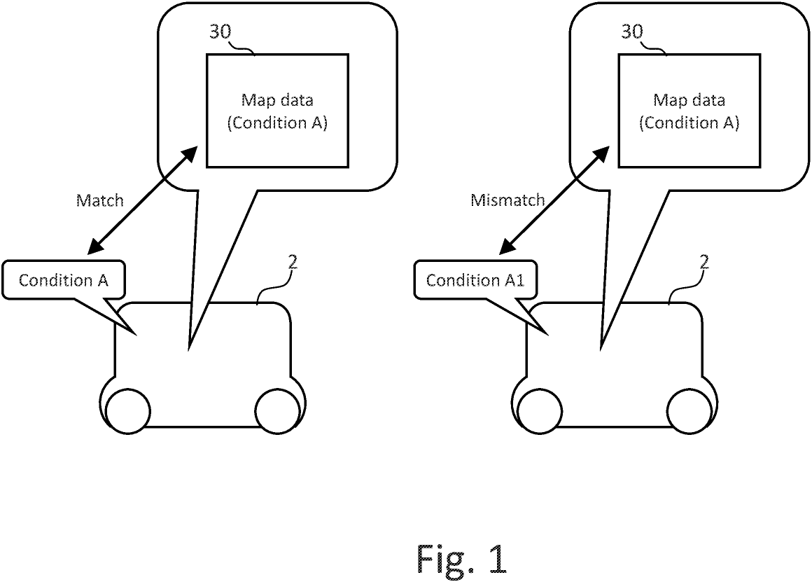

Autonomous driving using map data created using travel log data has one problem. FIG. 1 is a conceptual diagram for explaining a problem of automatic driving based on map data.

In general, the map data 30 is generated using a large number of travel log data so as to realize the highest accuracy. The travel log data is defined using a plurality of parameters including a parameter related to the internal state of the autonomous driving vehicle 2 and a parameter related to the external state of the autonomous driving vehicle 2. The parameter related to the internal state is, for example, a difference in vehicle, a difference in sensor configuration, or the like. The parameter related to the external state is, for example, weather, a time zone, a road environment, or the like. Here, a combination of conditions of parameters with which the map data 30 with the highest accuracy is obtained is defined as a condition A.

As in the example illustrated on the left side of FIG. 1, when the combination of the conditions of the parameters related to the autonomous driving of the autonomous driving vehicle 2 is condition A, the condition of the autonomous driving vehicle 2 matches the condition assumed by the map data 30. In this case, the autonomous driving vehicle 2 can perform autonomous driving by sufficiently using the map data 30 created with high accuracy.

However, the condition of the parameters related to automatic driving dynamically changes. Therefore, as in the example illustrated on the right side of FIG. 1, the combination of the conditions of the parameters related to the autonomous driving of the autonomous driving vehicle 2 may be a condition A1 different from condition A. Here, it is assumed that condition A1 is a condition which does not satisfy a part of condition A which is a combination of conditions of a plurality of parameters. In this case, the condition of the autonomous driving vehicle 2 does not match the condition assumed by the map data 30. Therefore, there is a possibility that the autonomous driving vehicle 2 cannot sufficiently use the map data 30 created with high accuracy. However, although the autonomous driving vehicle 2 can detect a change in the conditions of parameters by itself, the autonomous driving vehicle 2 cannot determine how much influence the mismatch between the condition assumed by the map data 30 and the current condition of the autonomous driving vehicle 2 has.

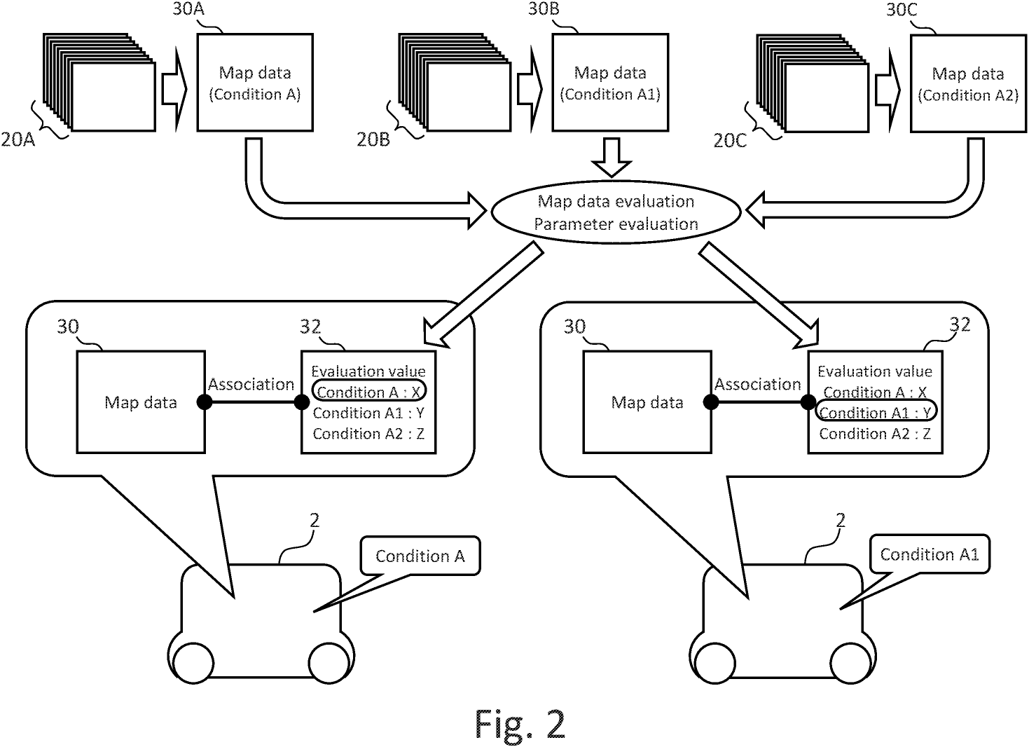

The map data generation method according to the present embodiment provides a solution to the above problem. FIG. 2 is a conceptual diagram for explaining an outline of the map data generation method according to the present embodiment.

According to the map data generation method according to the present embodiment, a plurality of data sets 20A, 20B, and 20C are generated from the travel log data group. The log data constituting the data set 20A is log data acquired under condition A. The log data constituting the data set 20B is log data acquired under condition A1. The log data constituting the data set 20C is log data acquired under condition A2. Condition A2 is different from condition A1 in the combination of the parameter conditions, and does not satisfy a part of condition A like condition A1. Although only three data sets 20A, 20B, and 20C are generated in FIG. 2, a larger number of data sets are actually generated. The number of log data constituting each data set is preferably plural, but may be one. The number of log data may be the same or different between data sets.

Next, map data 30A, 30B and 30C for evaluation are generated from the generated data sets 20A, 20B and 20C, respectively. Then, map data evaluation is performed on the map data 30A, 30B, and 30C for evaluation. In the map data evaluation, an evaluation value is calculated for each of the map data 30A, 30B, and 30C for evaluation. The evaluation value is an index indicating the accuracy of the map data, and is calculated based on a relative evaluation between map data, for example. Here, it is assumed that the evaluation values X, Y, and Z are obtained for the map data 30A, 30B, and 30C, respectively. A specific example of the evaluation value will be described later.

Further, parameter evaluation is performed based on the correspondence relationship between the datasets 20A, 20B, and 20C used to create the map data 30A, 30B, and 30C and the evaluation values of the map data 30A, 30B, and 30C. In the parameter evaluation, a relationship between a combination of conditions of a plurality of parameters defining the log data and an evaluation value is specified. In this example, the evaluation value is X when the combination of the conditions of a plurality of parameters is condition A, the evaluation value is Y when the combination of the conditions of a plurality of parameters is condition A1, and the evaluation value is Z when the combination of the conditions of a plurality of parameters is condition A2. By the parameter evaluation, relationship data 32 representing the relationship between the combination of the conditions of the plurality of parameters and the evaluation value is obtained.

The relationship data 32 is associated with the map data 30. The map data 30 is map data generated using all the log data included in the travel log data group. However, it is assumed that log data causing an abnormality in the accuracy of the map data is excluded from the travel log data group in advance. In the map data generation method according to the present embodiment, the map data 30 associated with the relationship data 32 is generated as the map data for autonomous driving. By using such map data 30 for autonomous driving, the autonomous driving vehicle 2 can draw an evaluation value corresponding to a current parameter condition related to autonomous driving from the relationship data 32 associated with the map data 30. Then, the vehicle behavior can be determined based on the evaluation value corresponding to the current parameter condition.

Specifically, when the autonomous driving vehicle 2 performs autonomous driving, the autonomous driving vehicle 2 acquires a current parameter condition in the autonomous driving vehicle 2, and acquires an evaluation value corresponding to the current parameter condition from the relationship data 32 associated with the map data 30. For example, in a case where the current parameter condition of the autonomous driving vehicle 2 is condition A, the autonomous driving vehicle 2 acquires the evaluation value X corresponding to condition A from the relationship data 32, and thus creates a traveling plan suitable for the evaluation value X. When the current parameter condition of the autonomous driving vehicle 2 is changed from condition A to condition A1, the autonomous driving vehicle 2 acquires the evaluation value Y corresponding to condition A1 from the relational database 32, thereby changing the travel plan from the travel plan suitable for the evaluation value X to the travel plan suitable for the evaluation value Y.

As described above, according to the map data generation method of the present embodiment, it is possible to generate map data capable of coping with a dynamic change in a condition of a parameter related to automatic driving.

### 2. Map Data Generation Apparatus and Autonomous Driving ECU

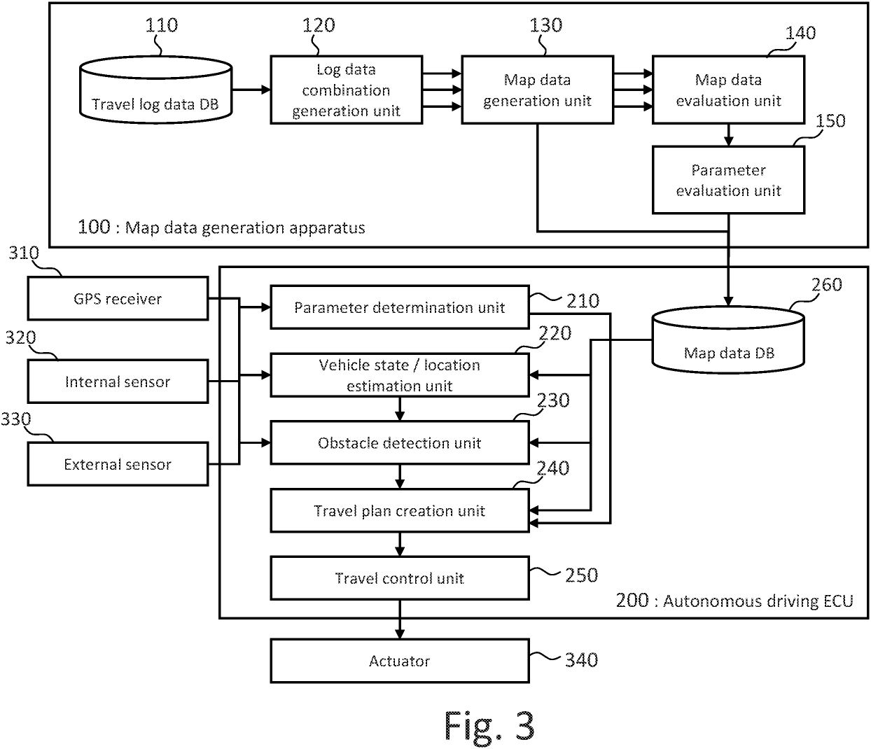

Next, a map data generation apparatus for implementing the map data generation method according to the present embodiment and an autonomous driving ECU that uses the map data generated by the map data generation apparatus for autonomous driving will be described. FIG. 3 is a block diagram illustrating functions of the map data generation apparatus 100 and the automatic driving ECU 200 according to the present embodiment.

The map data generation apparatus 100 includes a travel log data database (hereinafter referred to as a travel log data DB) 110 and a processing unit. The processing units included in the map data generation apparatus 100 are a log data combination generation unit 120, a map data generation unit 130, a map data evaluation unit 140, and a parameter evaluation unit 150.

The travel log data DB 110 is a database in which a large number of logs are stored. The log data acquired by actually driving a vehicle is accumulated in the travel log data DB 110 to form a travel log data group. The vehicle used to acquire the log data may be an autonomous driving vehicle or a vehicle driven by a driver. However, it is preferable that the type, the model, the number, and the installation location of the external sensor (the LiDAR, the camera, the depth sensor, or the like) used to acquire the log data are common to those of the autonomous driving vehicle in which the map data is used in the actual autonomous driving.

The log data includes data of various sensors and output data of each process of automatic driving. The various sensors include, for example, a GPS and an inertial measurement unit (IMU) in addition to the external sensor. The autonomous driving process includes, for example, a self-location estimation result, an object detection result, and a path plan result.

The log data is defined by a plurality of parameters. Examples of parameters and conditions thereof for defining the log data are as follows. One or more of these parameters are used to define the log data. The parameters related to sensors are set for each sensor. Sensors of the same type but different model numbers or different installation locations are handled as different sensors.
Vehicle type name: “Prius, e-Palette, Aqua, etc.” “8A2B, 300C, 405D, etc.”
Vehicle name: “vehicle 1, vehicle 2, vehicle 3, etc.” “Alice, Belle, Cindy, Cindy”
Date and time: “12:00, Aug. 12, 2021, 14:00, Aug. 12, 2021, etc.”
Total travel distance: “10 km, 5 km, etc.”
Time: “1 hour 21 minutes 14 seconds, 2 hours 3 minutes 43 seconds, etc.”
Weather: “sunny, rainy, cloudy, snowy, foggy, etc.”
Temperature: “30° C., 20° C., etc.” “86° F., 68° F., etc.”
Insolation: “0MJ/m2, 1.0MJ/m2, etc.”
Amount of rainfall: “0 mm/h, 1 mm/h, etc.” “0 mm, 2 mm, etc”
Snowfall amount: “0 mm/h, 1 mm/h, etc.” “0 mm, 2 mm, etc”
Operator name: “Taro Tanaka, Hanako Yamada, etc.” “No.101, No.203, etc.”
Number of passengers: “0, 1, 5, etc.” “vacant, present”
Vehicle speed: “maximum vehicle speed 20 km/h, 40 km/h, etc.” “average vehicle speed 10 km/h, 20 km/h, etc.”
Presence or absence of sensor: “presence, absence, failure”
Version of sensor: “Ver. 1, Ver. 2, etc.” “prototype, confirmed product, mass-produced product”
Version of autonomous driving software: “Ver. 1, Ver. 2, etc.” “master, perception test, planner test, etc.”
Operation method: “manual, automatic, partially automatic”

The log data combination generation unit 120 generates a combination of a plurality of log data, that is, a data set from the log data stored in the travel log data DB 110. The combination of log data constituting a data set is different for each data set. Specifically, among the log data constituting one data set, the combination of the conditions of the plurality of parameters that define the log data is the same. The combination of the conditions of the plurality of parameters that define log data is different for each data set.

The data range of the log data read from the travel log data DB 110 can be limited by the above parameters. Examples of data ranges that limit the log data include space, section, time, weather, temperature, vehicle, and sensor type. For example, a data range may be limited to “data taken by the sensor D of the vehicle A during the daytime on a sunny day”, and log data in such a data range may be combined to generate a data set. It is also possible to limit the data range to “data taken by the sensor D of the vehicle A during the daytime on a rainy day” and generate a data set by combining log data in such a data range. When the data range is limited as in these examples, it is possible to generate a data set whose condition is “sunny” and a data set whose condition is “rainy” with respect to the parameter “weather”. Thus, by appropriately limiting the data range of the log data to be read from the travel log data DB 110, the log data combination generation unit 120 generates a plurality of datasets with different combinations of parameter conditions.

The map data generation unit 130 generates map data for evaluation using the data set generated by the log data combination generation unit 120. The map data generation unit 130 generates one map data for evaluation for one data set. Thus, the map data generation unit 130 generates a plurality of map data for evaluation, the number of which is the same as the number of data sets generated by the log data combination generation unit 120.

The map data evaluation unit 140 evaluates the plurality of map data generated by the map data generation unit 130. Since a map is basically in a one to-one relationship with a real environment, the map data should converge uniquely regardless of the combination of log data. However, in the combination of log data generated by the log data combination generation unit 120, the combination of the conditions of the plurality of parameters that define the log data is intentionally made different for each data set. The content of the log data depends on the parameter conditions when it is acquired. For example, when the map data is a feature map, the feature included in the log data may vary depending on the parameter conditions. When there is a difference in the feature included in the log data, the difference may appear as a difference in accuracy of the map data. That is, there is a possibility that there is a difference in accuracy between the plurality of map data generated by the map data generation unit 130. The map data evaluation part 140 evaluates the accuracy of each map data and calculates an evaluation value. Examples of the method of calculating the evaluation value include a method of calculating a relative evaluation value by relative evaluation between map data and a method of calculating an absolute evaluation value based on a defined absolute reference.

The parameter evaluation part 150 evaluates the plurality of parameters that define the log data based on the evaluation value of the map data. Specifically, the parameter evaluation unit 150 specifies the parameter affecting the evaluation value of the map data based on the correspondence relationship between the evaluation value of each map data output from the map data evaluation unit 140 and the data set used to create the map data. Examples of such parameters include weather, number of sensors, a combination of sensors, etc. The parameter evaluation unit 150 also specifies the parameter that does not affect the evaluation value of the map data. Examples of such parameters include wind speed, a time period of day, etc. The parameter evaluation unit 150 evaluates how the combination of the conditions of each parameter affects the accuracy of the map data, and generates relationship data representing a relationship between the combination of the conditions of the plurality of parameters defining the log data and the evaluation value based on the evaluation result.

The relationship data generated by the parameter evaluation unit 150 is associated with the map data for autonomous driving generated by the map data generation unit 130. The map data for autonomous driving is generated using all the log data stored in the travel log data DB 110. That is, the map data for autonomous driving is map data having the largest amount of information and has the highest accuracy as map data. As described above, the relationship data generated by the parameter evaluation unit 150 represents the relationship between the combination of the conditions of the plurality of parameters defining the log data and the evaluation value. The map data for autonomous driving with which the relational data is associated is stored in a database (not illustrated) provided in the map data generation apparatus 100.

The autonomous driving ECU 200 is an ECU for autonomous driving provided in the autonomous driving vehicle. The autonomous driving ECU 200 includes a map database (hereinafter referred to as a map DB) 260 and a processor. The map data DB 260 stores map data for autonomous driving associated with the relationship data. The map data for autonomous driving associated with the relationship data is acquired from the map data generation apparatus 100 via a network or a computer-readable storage medium. The processing units constituting the autonomous driving ECU 200 are a parameter determination unit 210, a vehicle state / location estimation unit 220, an obstacle detection unit 230, a travel plan creation unit 240, and a travel control unit 250.

The parameter determination unit 210 determines the conditions of parameters related to automatic driving of the ego-vehicle. The parameters whose conditions are determined by the parameter determination unit 210 are the same type as the parameters that define the log data used to create the map data stored in the map data DB 260. The parameter determination unit 210 determines the conditions of parameters using sensor data acquired from the GPS receiver 310, the internal sensor 320, and the external sensor 330. The internal sensor 320 is a sensor that detects a traveling state of the ego-vehicle, and includes at least one of a vehicle speed sensor, an acceleration sensor, and a yaw rate sensor. The external sensor 330 is a sensor that detects an external situation that is peripheral information of the ego-vehicle, and includes at least one of a LiDAR, a camera, and a radar. The parameter whose condition is determined by the parameter determination unit 210 includes a parameter indicating an external state of the ego-vehicle such as a time period of day and weather, and a parameter indicating an internal state of the ego-vehicle such as a sensor configuration, a sensor failure state, and a vehicle name.

The vehicle state / location estimation unit 220 recognizes the traveling state of the ego-vehicle based on the sensor data of the internal sensor 320. The sensor data of the internal sensor 320 is, for example, vehicle speed information of a vehicle speed sensor, acceleration information of an acceleration sensor, yaw rate information of a yaw rate sensor, or the like. The vehicle state / location estimation unit 220 estimates the location of the ego-vehicle on the map based on the information on the current location (for example, latitude and longitude) of the ego-vehicle received by the GPS receiver 310 and the map data stored in the map data DB 260.

The obstacle detection unit 230 detects obstacles (vehicles, motorcycles, pedestrians, animals, fallen objects, and the like) present outside the ego-vehicle using the sensor data of the external sensor 330 and the map data stored in the map data DB 260.

The travel plan creation unit 240 creates a travel plan of the ego-vehicle. The travel plan includes a path of the ego-vehicle. The path is a trajectory followed by the ego-vehicle, and is defined by a future target location and a target speed or acceleration at the target location. A target route on the map data stored in the map data DB 260 is used to create the travel plan. In addition, the vehicle state and the vehicle location of the ego-vehicle estimated by the vehicle state / location estimation unit 220 and the information on the obstacle outside the ego-vehicle recognized by the obstacle detection unit 230 are used to create the travel plan.

Further, the travel plan creation unit 240 uses the evaluation value for each combination of the parameters associated with the map data stored in the map data DB 260 and the current conditions of the parameters of the ego-vehicle acquired by the parameter determination unit 210 to create the travel plan. Specifically, the travel plan creation unit 240 collates the combination of the current parameter conditions of the ego-vehicle acquired by the parameter determination unit 210 with the map data stored in the map data DB 260, and acquires the evaluation value corresponding to the combination of the current parameter conditions. The travel plan creation unit 240 creates the travel plan of the ego-vehicle based on the evaluation value corresponding to the combination of the current parameter conditions.

The travel control unit 250 automatically controls the travel of the ego-vehicle based on the travel plan created by the travel plan creation unit 240. The travel control unit 250 outputs a control signal corresponding to the travel plan to the actuator 340. When the actuator 340 operates in accordance with the control signal, the ego-vehicle automatically travels in accordance with the travel plan. The actuator 340 includes at least a driving actuator, a braking actuator, and a steering actuator.

Next, an example of a hardware configuration of each of the map data generation apparatus 100 and the autonomous driving ECU 200 for realizing the above-described functions will be described.

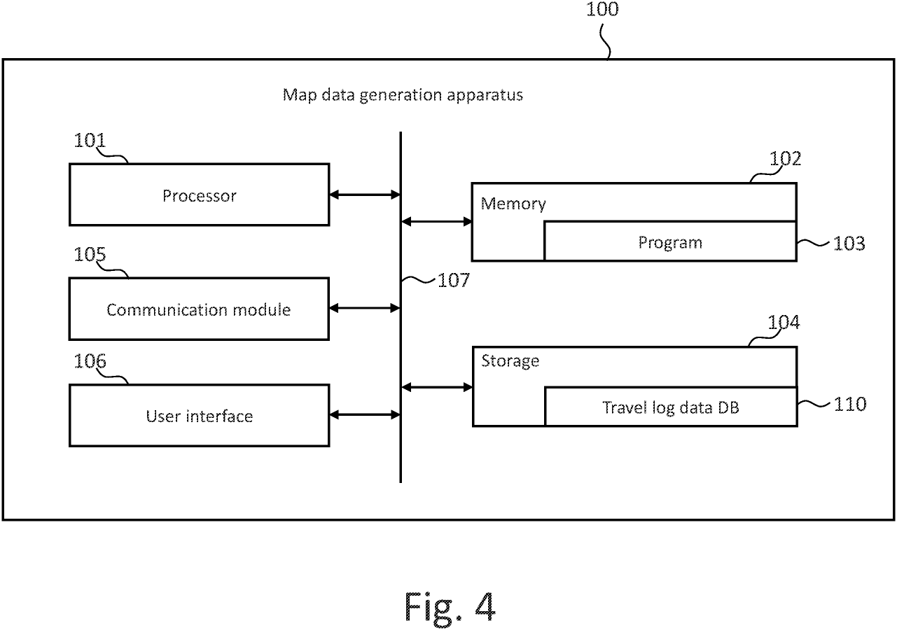

FIG. 4 is a block diagram illustrating an example of a hardware configuration of the map data generation apparatus 100 according to the present embodiment. In the example illustrated in FIG. 4, the map data generation apparatus 100 includes a processor 101, a memory 102, a storage 104, a communication module 105, and a user interface 106. These elements constituting the map data generation apparatus 100 are connected to each other by a bus 107.

The processor 101 performs calculation for generating map data. The number of the processors 101 provided in the map data generation apparatus 100 may be one or more (here, it is assumed that one processor is provided).

The memory 102 is a non-transitory program memory that stores a program 103. The program 103 includes a plurality of instructions for causing the processor 101 to perform processing. The program 103 is a computer-executable program (map data generation program) for implementing the map data generation method according to the present embodiment. The program 103 is executed by the processor 101 to cause the processor 101 to function as the log data combination generation unit 120, the map data generation unit 130, the map data evaluation unit 140, and the parameter evaluation unit 150.

The storage 104 is, for example, a flash memory, an SSD, or an HDD. A travel log data DB 110 is stored in the storage 104. However, the travel log data DB 110 may be provided outside the map data generation apparatus 100. Further, the storage 104 may be provided with a database for registering the map data for autonomous driving generated by the map data generation apparatus 100.

The communication module 105 is provided for communication with external devices. A communication method by the communication module 105 may be wireless communication or wired communication. The storing of the log data to the travel log data DB110 and the reading of the map data for autonomous driving are performed using the communication module 105.

The user interface 106 is provided for inputting an operation by an operator of the map data generation apparatus 100 and outputting information to the operator.

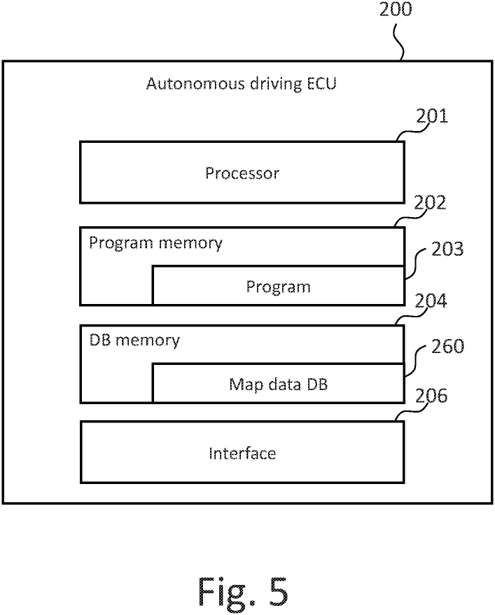

FIG. 5 is a block diagram illustrating an example of a hardware configuration of the autonomous driving ECU 200 according to the present embodiment. In the example illustrated in FIG. 5, the autonomous driving ECU 200 includes a processor 201, a program memory 202, a DB memory 204, and an interface 206.

The processor 201 performs calculation and control for automatic driving. The processor 201 is coupled to the program memory 202, the DB memory 204 and the interface 206.

The program memory 202 is a non-transitory memory that stores the program 203. The program 203 includes a plurality of instructions for causing the processor 201 to perform processing. The program 203 includes a program (travel plan creation program) executable by a computer for implementing the travel plan creation method according to the present embodiment. The program 203 is executed by the processor 201 to cause the processor 201 to function as the parameter determination unit 210, the vehicle state / location estimation unit 220, the obstacle detection unit 230, the travel plan creation unit 240, and the travel control unit 250.

The DB memory 204 is a non-transitory memory that stores the map date DB 260. The DB memory 204 and the program memory 202 may be physically separate memories, or may be different storage areas of one memory.

The interface 206 is provided for input and output of signals with devices such as the GPS receiver 310, the internal sensor 320, the external sensor 330, and the actuator 340. The interface 206 and these devices are connected by an in-vehicle network such as a controller area network (CAN).

### 3. Specific Example of Map Data Generation Method

Next, a specific example of a map data generation method performed by the map data generation apparatus 100 according to the present embodiment will be described.

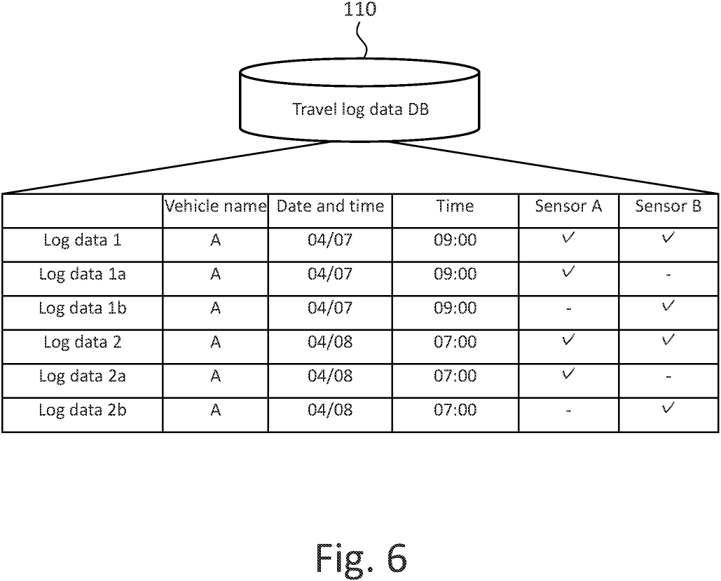

FIG. 6 is a conceptual diagram illustrating an example of the configuration of the travel log data DB 110 in the map generation method. In this example, the parameters defining the log data are the vehicle name, the date and time, the time period of day, the presence or absence of data of sensor A, and the presence or absence of data of sensor B. Six log data are stored in the travel log data DB 110. Log data 1a and log data 1b are partial data of log data 1. While log data 1 includes each data of sensor A and sensor B, log data 1a includes only the data of sensor A, and log data 1b includes only the data of sensor B. Similarly, log data 2a and log data 2b are partial data of log data 2. While log data 2 includes each data of sensor A and sensor B, log data 2a includes only the data of sensor A, and log data 2b includes only the data of sensor B. Note that the content of the log data varies depending on the type of map data to be finally generated. Since the map data generation method according to the present embodiment can be widely applied as long as the map data is generated from the log data, the content of the log data is not limited here.

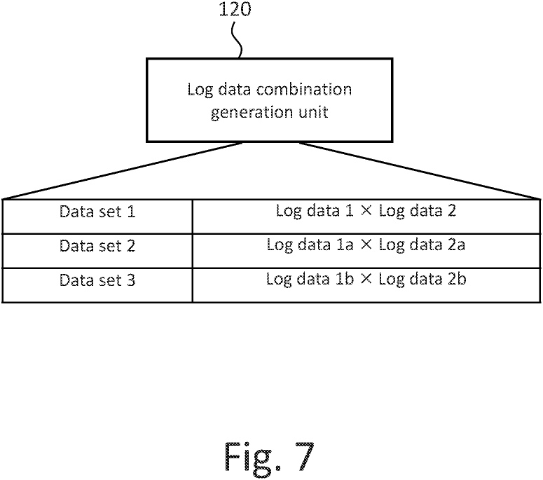

FIG. 7 is a conceptual diagram for explaining log data combination generation processing performed by the log data combination generation unit 120. The log data combination generation unit 120 generates a data set by combining the six log data stored in the travel log data DB 110. In this example, the combination of log data is performed for each parameter condition. The parameters of interest are the presence or absence of data of sensor A and the presence or absence of data of sensor B. Data set 1 is a combination in which the conditions of the parameters are the presence of data of sensor A and the presence of data of sensor B, and is constituted by log data 1 and log data 2. Data set 2 is a combination in which the conditions of the parameters are the presence of data of sensor A and the absence of data of sensor B, and is constituted by log data 1a and log data 2a. Data set 3 is a combination in which the conditions of the parameters are the absence of data of sensor A and the presence of data of sensor B, and is constituted by log data 1b and log data 2b.

Next, map data generation processing performed by the map data generation unit 130, map data evaluation processing performed by the map data evaluation unit 140, and parameter evaluation processing performed by the parameter evaluation unit 150 will be described using two calculation examples.

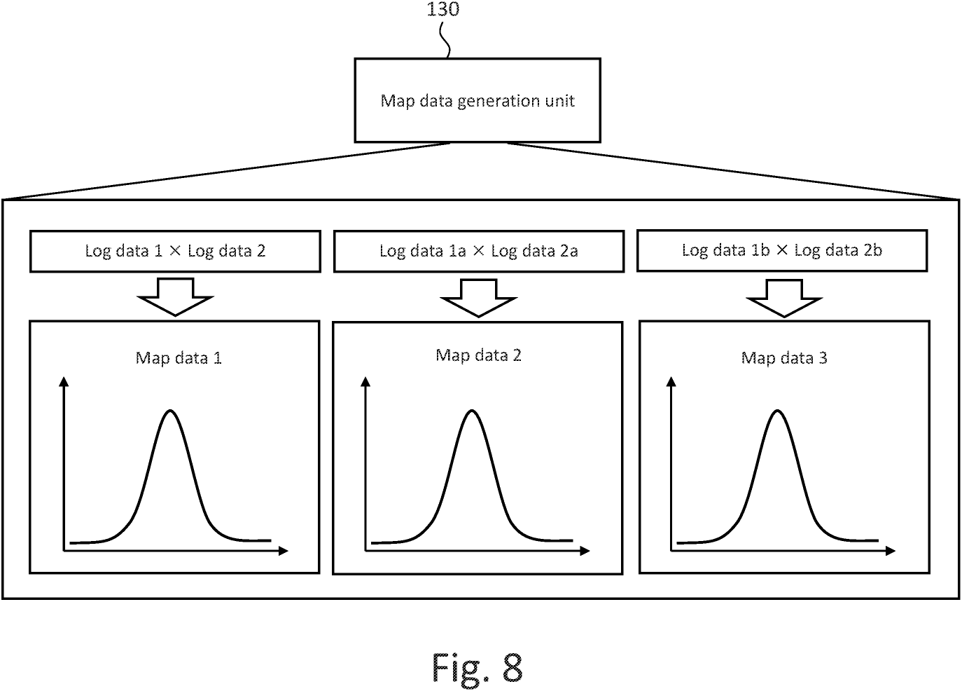

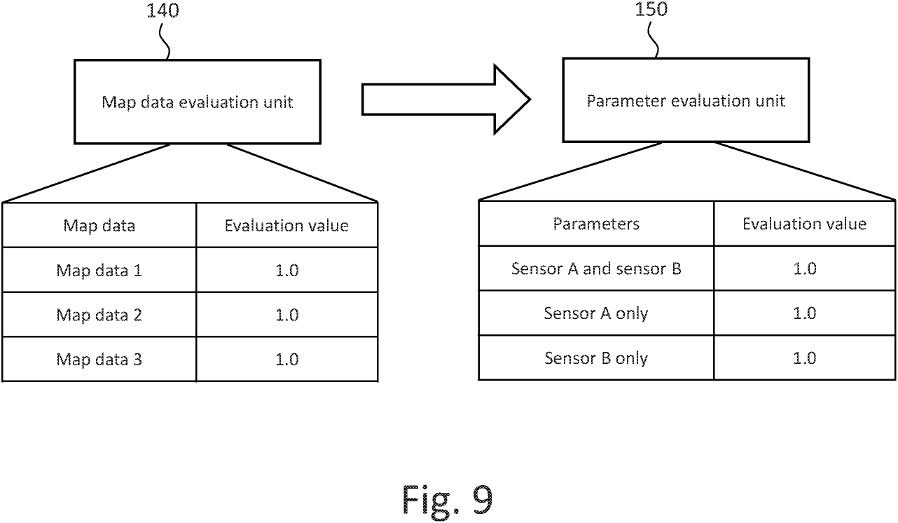

First, a first calculation example will be described with reference to FIGS. 8 and 9. FIG. 8 is a conceptual diagram for explaining the map data generation processing performed by the map data generation unit 130. The map data generation unit 130 generates map data from each of the three data sets generated by the log data combination generation unit 120. Map data 1 is generated from log data 1 and log data 2. Map data 2 is generated from log data 1a and log data 2a. Then, map data 3 is generated from log data 1b and log data 2b. These three map data are map data for evaluation.

For example, when the map data is data of a feature map, the degree of variation in the feature of the entire map is represented by a standard deviation or a probability distribution. In the example shown in FIG. 8, the degree of variation of the element data constituting the map data is represented by a probability distribution as an image of the map data. In the first calculation example of the map data shown in FIG. 8, the probability distributions of map data 1, map data 2, and map data 3 indicate normal distributions, and the degrees of convergence to the average values are substantially the same.

FIG. 9 is a conceptual diagram for explaining about the map data evaluation processing performed by the map data evaluation unit 140 and the parameter evaluation processing performed by the parameter evaluation unit 150. The map data evaluation unit 140 compares the map data generated by the map data generation unit 130 with each other and relatively evaluates them. In the first calculation example of the map data shown in FIG. 8, there is no difference in the degree of convergence between the map data, and all of them show normal distributions. Therefore, in the first calculation example, the map data evaluation unit 140 gives an evaluation value of 1 to each map data. Here, the evaluation value is a numerical value from 0 to 1, and the larger the numerical value is, the higher the accuracy of the map data is.

The parameter evaluation unit 150 evaluates each condition of the parameter based on the evaluation value of each map data received from the map data evaluation unit 140. In the specific example described this time, since the map data and the condition of the parameter are associated with each other on a one to-one basis, the evaluation value of the map data is directly adopted as the evaluation value of the condition of the parameter. In other words, in the first calculation example, the parameter evaluation unit 150 gives an evaluation value of 1 to all combinations of parameter conditions. In this way, the relationship data representing the relationship between the combination of the conditions of the plurality of parameters and the evaluation value is obtained.

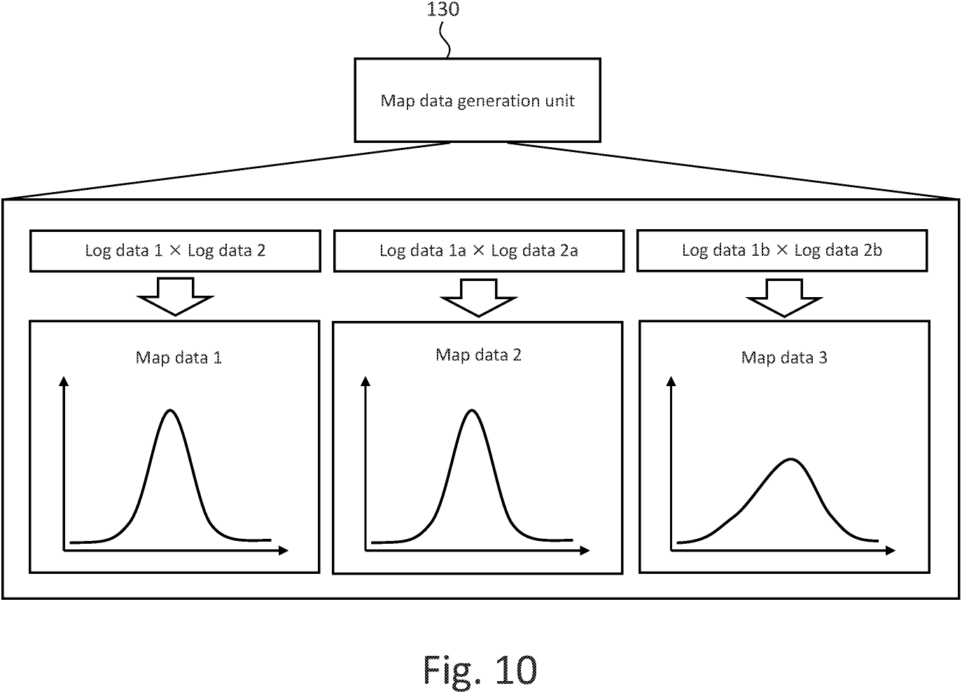

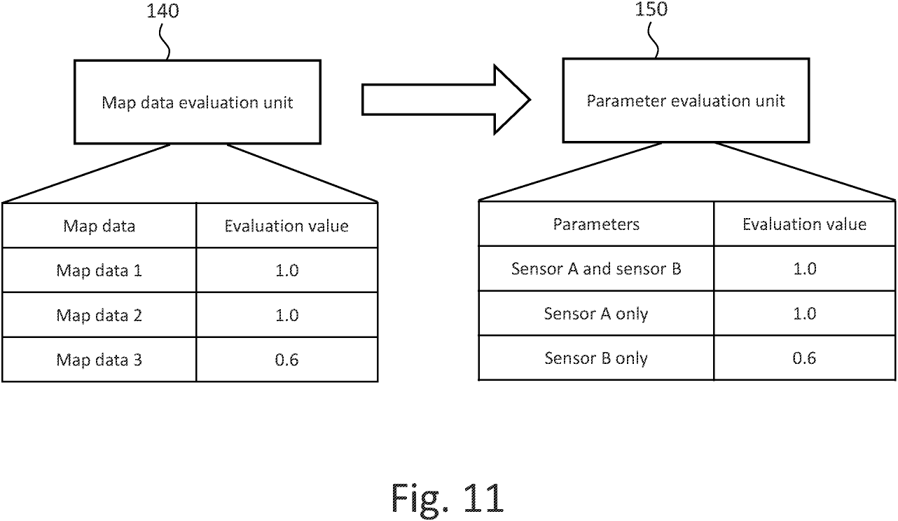

Next, a second calculation example will be described with reference to FIGS. 10 and 11. FIG. 10 shows a second calculation example of the map data by the map data generation unit 130. In the second calculation example of the map data shown in FIG. 10, the probability distributions of map data 1 and map data 2 indicate normal distributions, and the degrees of convergence to the average value are substantially the same between map data 1 and map data 2. On the other hand, the convergence degree of map data 3 is different from the convergence degrees of map data 1 and map data 2. Such a difference occurs in the accuracy of the map data due to the difference in the accuracy of the log data used.

FIG. 11 illustrates a second calculation example of the map data evaluation value by the map data evaluation unit 140 and a second calculation example of the parameter evaluation value by the parameter evaluation unit 150. It can be seen from the second calculation example of the map data shown in FIG. 10 that the accuracy of map data 3 is lower than that of map data 1 and map data 2 due to the difference in the degree of convergence. Therefore, in the second calculation example, the map data evaluation unit 140 gives an evaluation value of 1 to map data 1 and map data 2, and gives an evaluation value of 0.6 to map data 3. However, the evaluation value of 0.6 is merely an example. A specific calculation method of the evaluation value will be described later.

In the second calculation example, the parameter evaluation unit 150 gives the evaluation value 1 to the combination of the parameter conditions corresponding to map data 1 and the combination of the parameter conditions corresponding to map data 2. On the other hand, the parameter evaluation unit 150 gives an evaluation value of 0.6 to the combination of parameter conditions corresponding to map data 3. In this way, the relationship data representing the relationship between the combination of the conditions of the plurality of parameters and the evaluation value is obtained.

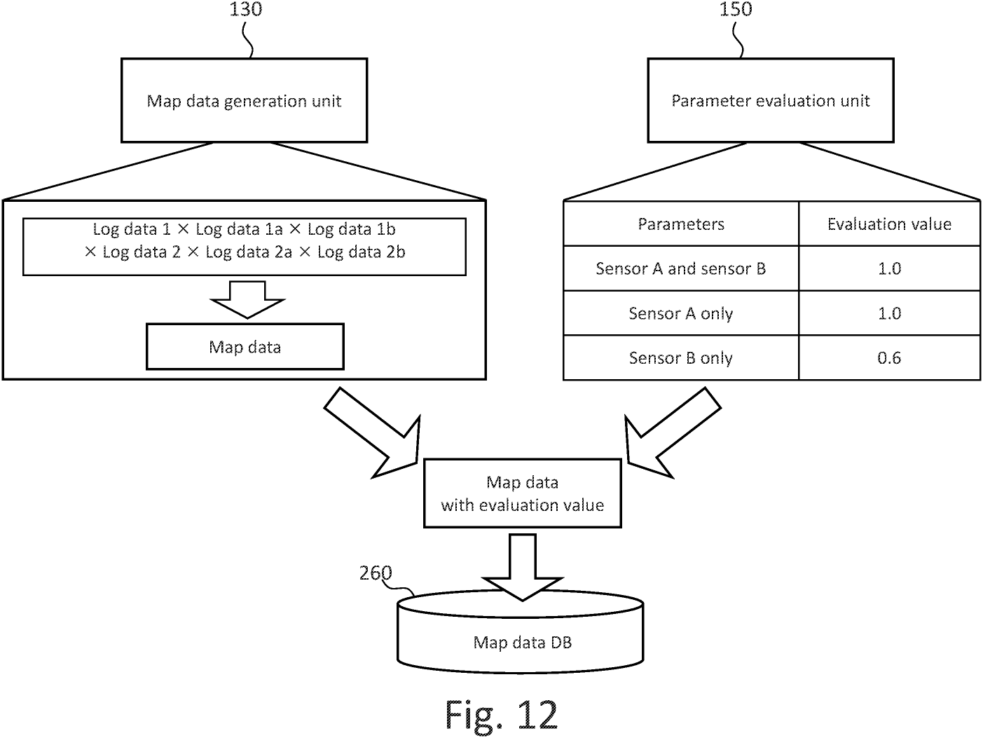

FIG. 12 is a conceptual diagram for explaining the autonomous driving map data registered in the map data DB 260. As shown in FIG. 12, the map generation unit 130 generates the map data for autonomous driving using all the log data registered in the travel log data DB 110. Then, the relationship data obtained by the parameter evaluation unit 150, that is, the relationship between the combination of the conditions of the plurality of parameters and the evaluation value is associated with the map data for autonomous driving. In the map data DB 260, the map data for autonomous driving associated with the relationship data is registered.

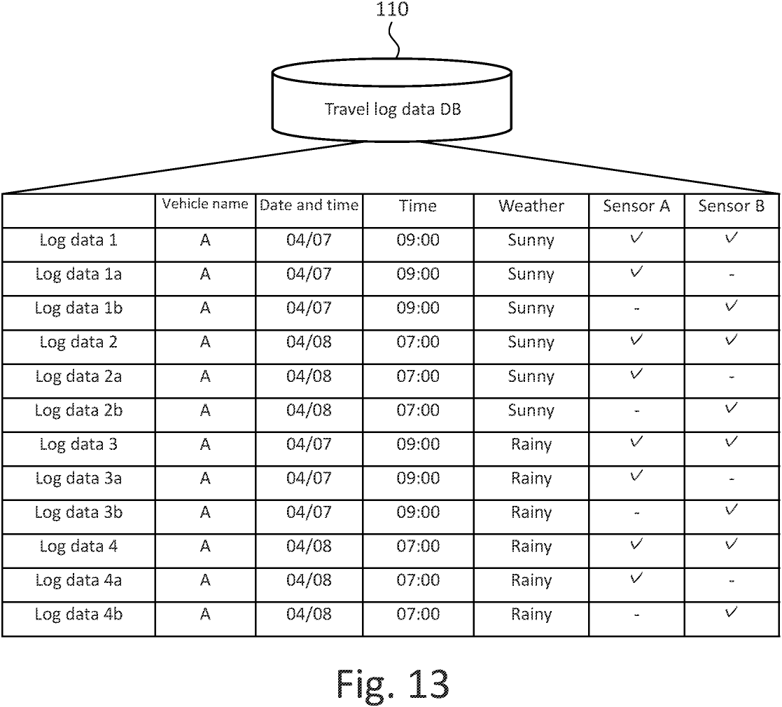

Here, the format of the log data stored in the travel log data DB 110 will be described. FIG. 13 is a conceptual diagram for explaining an example of the format of the log data stored in the travel log data DB 110.

In the example illustrated in FIG. 13, the parameters that define the log data are the vehicle name, the date and time, the time period of day, the weather, the presence or absence of data of sensor A, and the presence or absence of data of sensor B. Twelve log data are stored in the travel log data DB 110. The six log data in the upper row are log data acquired on a sunny day, and include log data 1 and 2 including the respective data of the sensors A and B, log data 1a and 2a including only the data of sensor A, and log data 1b and 2b including only the data of sensor B. The six log data in the lower row are log data acquired on a rainy day, and include log data 3 and 4 including the respective data of sensor A and sensor B, log data 3a and 4a including only the data of sensor A, and log data 3b and 4b including only the data of sensor B.

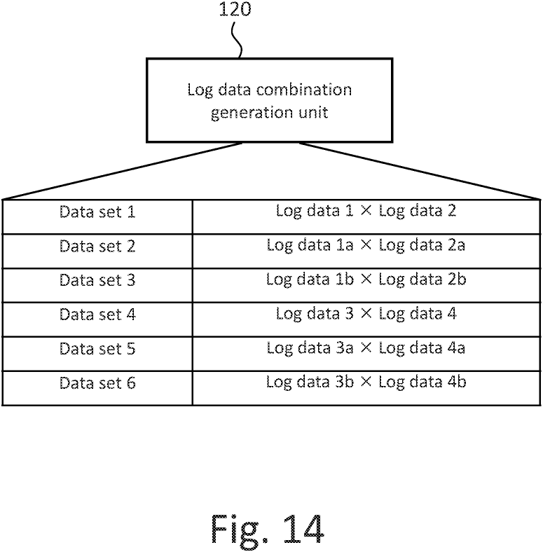

When the log data stored in the travel log data DB 110 are as shown in FIG. 13, in the log data combination generation processing, the log data are combined as shown in FIG. 14. FIG. 14 is a conceptual diagram for explaining an example of the format of the combination of log data.

In the example illustrated in FIG. 14, the log data combination generation unit 120 generates a data set by combining twelve log data stored in the travel log data DB 110. The parameters of interest in this example are the presence or absence of data of sensor A, the presence or absence of data of sensor B, and the weather. Data set 1 and data set 4 are combinations of log data in which the conditions of the parameters are the presence of data of sensor A and the presence of data of sensor B. Data set 2 and data set 5 are combinations of log data in which the conditions of the parameters are the presence of data of sensor A and the absence of data of sensor B. Data set 3 and data set 6 are combinations of log data in which the conditions of the parameters are the absence of data of sensor A and the presence of data of sensor B. Data set 1, data set 2, and data set 3 are combinations of log data in which the conditions of the parameters are fine weather, and data set 4, data set 5, and data set 6 are combinations of log data in which the conditions of the parameters are rainy weather.

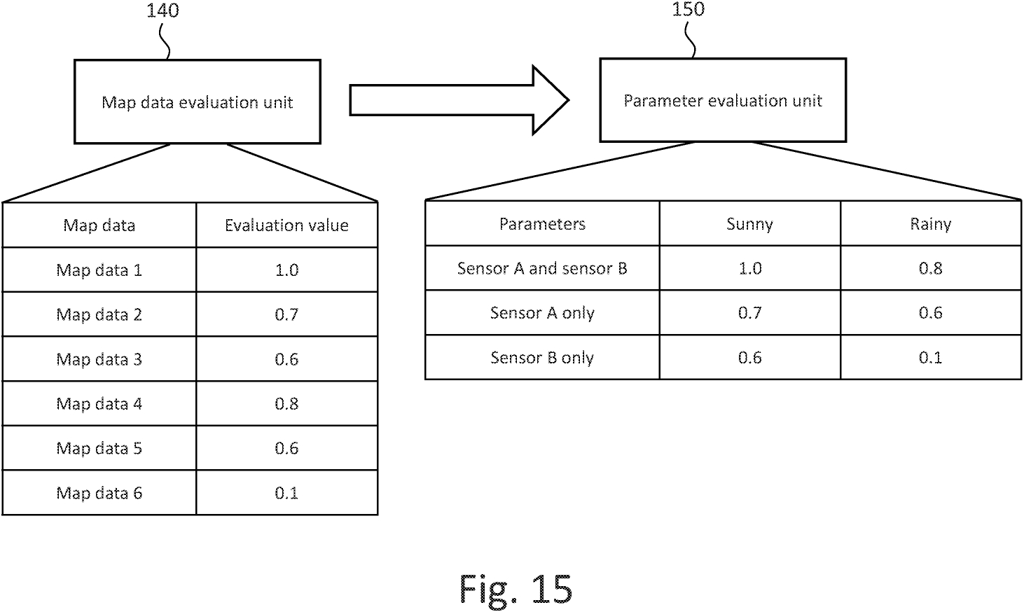

When the data sets shown in FIG. 14 are obtained by the log data combination generation unit 120, the map data evaluation unit 140 calculates an evaluation value for each map data generated from each data set. The parameter evaluation unit 150 generates relationship data representing a relationship between the combination of the conditions of the parameters and the evaluation value based on the evaluation value for each map data by the map data evaluation unit 140. FIG. 15 is a conceptual diagram for explaining an example of a correspondence relationship between the combination of the conditions of the parameters and the evaluation value in the parameter evaluation processing.

In the example shown in FIG. 15, as shown in a table, the evaluation value is represented by a matrix of “weather” and “combination of presence or absence of data of the sensors A and B”. According to this table, it is understood that the evaluation value depends not only on the presence or absence of data of the sensors A and B but also on the weather. Here, it is assumed that the evaluation value at which the autonomous driving can be continued is 0.5 or more. In this case, from the table, if sensor A is usable, it can be determined that autonomous driving can be continued regardless of whether sensor B is usable or not and regardless of weather. In addition, when sensor A is unusable and sensor B is usable, it can be determined that the automatic driving can be continued when it is fine but cannot be continued when it rains.

In the example shown in FIG. 15, the combination of the conditions of the parameters is evaluated in two dimensions, but can be expanded to three or more dimensions according to the number of combinations of the conditions of the parameters. Further, the parameter evaluation may be performed not only for a combination of conditions of a plurality of parameters but also for a condition of a single parameter. For example, the evaluation target may be only the parameter “weather”, and the evaluation value may be obtained for each of the case where the condition is sunny and the case where the condition is rainy.

### 4. Specific Example of Map Data Evaluation Processing

### 4-1. Map Data Evaluation Processing for Feature Map

### 41. Outline of Feature Map

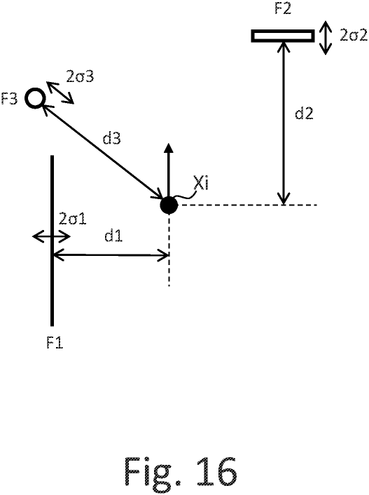

In the above description, the degree of variation of the element data constituting the map data (the degree of convergence of the map data) is visually expressed by the probability distribution. However, this is an example of an evaluation method for specifying the map data having an abnormality, and it is not always necessary to perform evaluation by observing only the degree of convergence of a certain statistical numerical value. Hereinafter, an outline of a map actually used in the autonomous driving system will be described, and a specific example of the map data evaluation processing corresponding to each map will be described. FIGS. 16 to 24 are diagrams for explaining a specific example of the map data evaluation processing performed by the map data generation apparatus 100 according to the present embodiment.

First, the feature map will be described. The feature map is map data used by the autonomous driving vehicle for the self-location estimation. The feature map is generated by superimposing unique features acquired from sensor data of the LiDAR or the camera and performing optimization calculation, specifically, simultaneous localization and mapping (SLAM). As the feature, for example, a white line, a curb (step), a road sign, a pole supporting the road sign, a reentrant angle of a building, or the like is detected. Since distance accuracy is required in automatic driving, the LiDAR is an example of a preferable external sensor. In the example described below, the feature is acquired by the LiDAR.

When the feature map is generated, the feature obtained from each data is superimposed on the output of the locator (GPS and IMU). The output of the locator is coordinates (x, y, z) and attitude (roll, pitch, yaw). However, if the features of all the log data are merely superimposed in accordance with the output of the locator, the features remain varied. Therefore, SLAM, that is, optimization calculation is performed on a result obtained by superimposing features of all log data. The feature map obtained by performing the optimizing calculation is stored in the map database DB 260 as a map database for autonomous driving, and is used for the self-location estimation when the autonomous driving vehicle actually travels.

### 42. Evaluation of Map Data Based on Degree of Success of Self-Location Estimation

When the feature map is generated, a pose indicating the location and posture of the vehicle is used. A line connecting the poses of the vehicle at each time is a path through which the vehicle has passed. In SLAM, the feature is optimized, and at the same time, each pose is also optimized using the feature detected at the pose. The degree of success of self-localization at a pose by SLAM can be obtained from statistical values described below.

FIG. 16 is a conceptual diagram for explaining an example of the self-location estimation at a pose by SLAM. FIG. 16 shows the pose Xi of the vehicle at time ti and the features F1, F2, and F3 observed at the pose Xi. The feature F1 is a white line, the feature F2 is a road sign, and the feature F3 is a pole. The measurement distances d1, d2, and d3 of the features F1, F2, and F3 obtained by the LiDAR include predetermined measurement errors σ1, σ2, and σ3. In SLAM, the self-location estimation for the pose Xi is performed based on the locations, measured distances, and measurement errors of the features F1, F2, and F3.

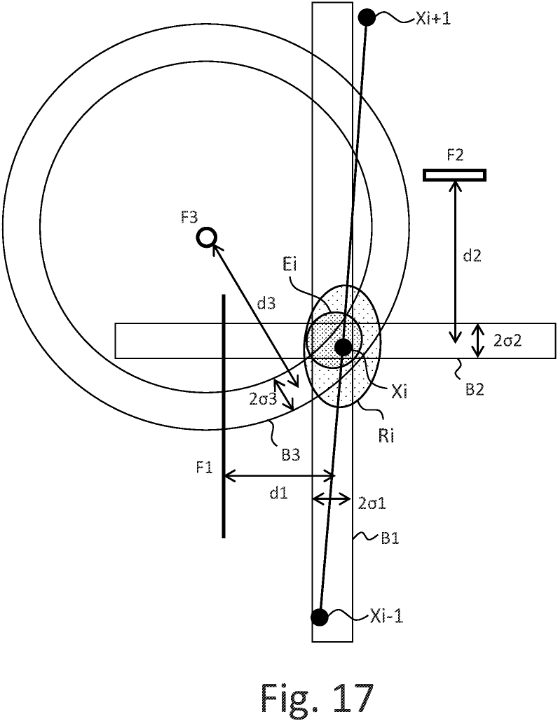

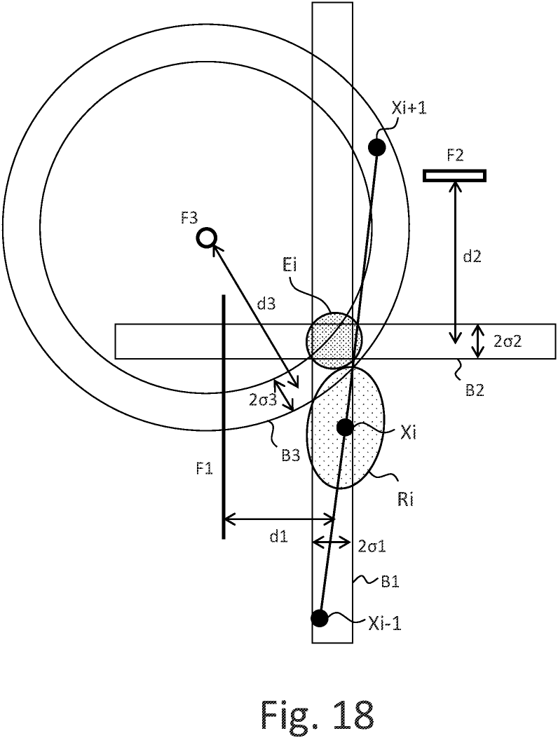

FIGS. 17 and 18 are conceptual diagrams for explaining a result of the self-location estimation at a pose by SLAM. The band-shaped areas B1, B2, and B3 in FIGS. 17 and 18 are defined by the locations, measured distances, and measurement errors of the features F1, F2, and F3. More specifically, the band-shaped areas B1, B2, and B3 are separated from the locations of the features F1, F2, and F3 by the measurement distances d1 to d3, and have widths of 2σ1 to 2σ3. An area Ei where the three areas B1, B2, and B3 overlap is an estimation area of the self-location. It can be determined that the degree of success of the self-location estimation at the pose Xi is higher as the area where the estimation area Ei of the self-location and the area Ri around the pose Xi overlap is larger. FIG. 17 indicates a successful example of the self-location estimation at the pose Xi. In FIG. 17, the self-location estimation area Ei and the area Ri around the pose Xi overlap each other. On the other hand, FIG. 18 indicates a failure example of the self-location estimation at the pose Xi. In FIG. 18, the self-location estimation area Ei and the area Ri around the pose Xi do not overlap each other.

In general, the chi-square value may be calculated to determine the consistency of the feature observed at the pose Xi. The chi-square value is calculated using, for example, the expected value and the observed value of the measured distance of the feature. The probability of occurrence of the chi-square value at the pose Xi can be represented by a p-value. As the chi-square value increases, the p-value decreases, and as the chi-square value decreases, the p-value increases. The degree of success of self-localization at the pose Xi by SLAM is represented by the p-value as a probability ranging from 0 (highly likely to fail) to 1 (highly likely to succeed).

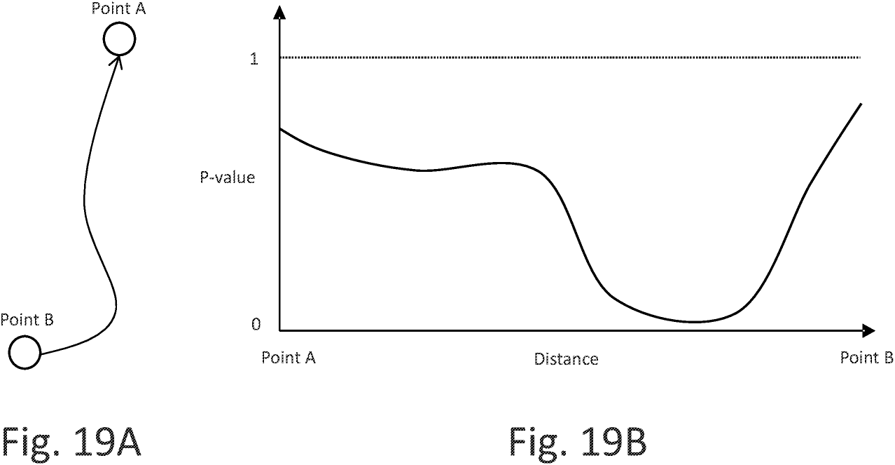

The p-value is basically location-dependent. The p-value is low in a section in which the feature cannot be sufficiently acquired or in a section in which the feature that can be acquired is biased. On the other hand, the p-value is high in a section in which the feature can be sufficiently detected. For example, it is assumed that the map date is created using the log date acquired in the section from point A to point B shown in FIG. 19A. By plotting the p-values on a graph in which the horizontal axis represents the distance from point A, the relationship between the location and the p-value as shown in FIG. 19B is obtained. Since it can be considered that the p-value indicates a probability that the map data at the location is accurately generated, the p-value can be used as an evaluation value as it is. For example, if the evaluation value of the map data or a certain section is calculated as a scalar quantity, the average value of the p-values of the entire map data or the certain section may be used as the evaluation value.

When the p-value is used as the evaluation value, the p-value can be held while leaving the information of the location. One method is to store the p-value at the location of the pause of the travel log data corrected by SLAM. In another method, a two-dimensional cell for the p-value is prepared, and p-values of poses within a predetermined distance from the cell are averaged and held in the cell. In another method, p-values of poses within a predetermined distance from a waypoint of a base path are averaged and held in the waypoint. Note that the base path is a type of map data used in autonomous driving, and represents where the ego-vehicle travels on the map by a trajectory. The base path is also used to predict where other vehicles will travel. In the base path, data is held in the form of regularly spaced waypoints.

The p-value in the feature map is a value representing the degree of success of the self-location estimation by a probability. However, even in a place where the p-value is low and the self-location estimation is highly likely to fail, if the road width is extremely wide, it is possible to continue the automatic driving. For example, even though the self-location estimation may be wrong by 1 m, if the road width is 5 m, the autonomous driving can continue. However, even if the possibility that the self-location estimation fails is not high, when the gap between the entire width of the ego-vehicle and the road width is narrow, the possibility that the ego-vehicle deviates from the road is high, and thus the autonomous driving cannot be continued. For example, even if the possibility of making a mistake in the self-location estimation is about 0.2 m, if the gap is only 0.1 m, it is impossible to continue autonomous driving.

As described above, it is also possible to calculate the evaluation value in consideration of not only the p-value of the pose but also the distance from the nearest feature around the pose. Also, returning to the definition of the p-value, the p-value can be converted into a pose distance error. Therefore, with respect to a certain pose, an evaluation value can be obtained based on a distance from the pose to the closest feature and a distance at which the self-location estimation at the pose is likely to fail.

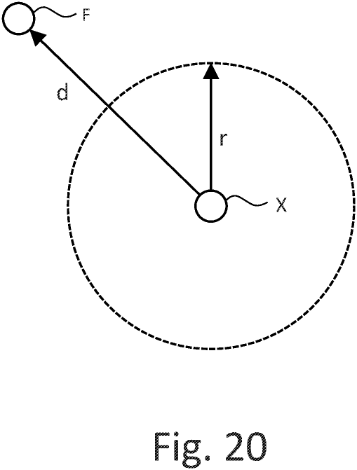

For example, it is assumed that there is a pause X in which a certain p-value is recorded as shown in FIG. 20. In this case, when the error of the distance calculated from the p-value is r and the distance from the pose X to the closest feature F is d, the evaluation value e can be expressed by the following equation. e=d-r

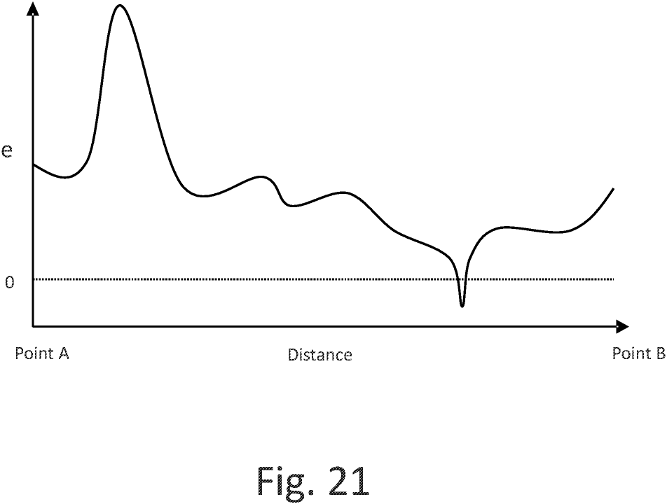

In this case, since the evaluation value e increases as the distance to the closest feature F has a margin, the larger the evaluation value e is, the more suitable the automatic driving is. On the other hand, when the evaluation value e is equal to or less than 0, it means that there is a possibility that the ego-vehicle collides with the closest feature F. For example, it is assumed that the relationship between the evaluation value e and the distance shown in FIG. 21 is obtained by calculating the evaluation value e from the p-value recorded at the pose and the distance d from the pose to the closest feature for each pose from point A to point B. In the example shown in FIG. 21, the evaluation value is 0 or more for a while from point A, but the evaluation value is lower than 0 at a certain point. This means that the accuracy of the self-location estimation at that point may cause the vehicle to collide with the feature.

### 43. Evaluation of Map Data Based on Statistics of Entire Map

As described above, the optimization calculation is performed when the feature map is generated. Although the degree of matching of the features is increased by the optimization calculation, the features do not necessarily completely match between all the log data. The location of the feature after the optimization calculation varies due to a plurality of reasons such as the detection accuracy of the LiDAR itself, the accuracy of calibration (attachment location and orientation) of the LiDAR, the accuracy of the feature detection algorithm, and the accuracy of the optimization calculation.

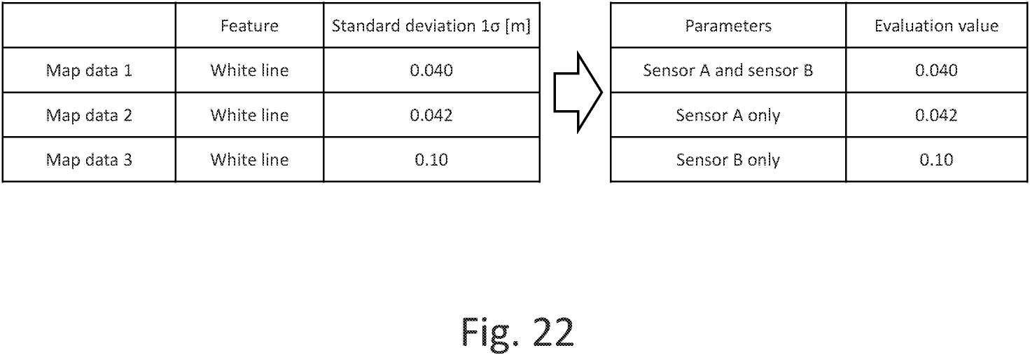

For example, when the feature is a white line, the standard deviation of the feature differs for each map data as shown in FIG. 22. Since the evaluation value is not necessarily defined as 0 (worst) to 1 (best), in this case, the standard deviation can be used as the evaluation value as it is. In the example shown in FIG. 22, the evaluation value is 0.040 when both the data of sensor A and the data of sensor B are present, the evaluation value is 0.042 when only the data of sensor A is present, and the evaluation value is 0.1 when only the data of sensor B is present. In this way, when the standard deviation is used as the evaluation value as it is, the accuracy becomes higher as the numerical value becomes smaller, and the accuracy becomes worse as the numerical value becomes larger. In the case of the p-value, an evaluation value can be set for each pose, but an evaluation value calculated using a statistic such as a standard deviation or a variance is an evaluation value for the entire map data.

4-2. Map Data Evaluation Processing for Road Surface Shape Map The road surface shape map is a map that expresses a road surface shape by information in the height direction held in two dimensional cells. In the road surface shape map, information is stored in each cell obtained by decomposing the image data in the x direction and the y direction at a predetermined resolution. In each cell of the road surface shape map, the number of points of the LiDAR reaching the cell, and the average value and the variance of the height of the points are stored. In the calculation of the average value and the variance of the height, the values of all LiDAR points (height values in the z direction) that have reached the cell are used.

Main uses of the road surface shape map in the autonomous driving vehicle are calculation of a road gradient when a base path is generated and object detection during autonomous driving. In particular, in the latter case, it is possible to reduce the calculation load for object detection by removing a large amount of LiDAR points reflected from the road surface from the object detection processing in the subsequent stage using the road surface shape. However, for this purpose, it is necessary to ensure the accuracy of the road surface shape with respect to the height of the object to be detected.

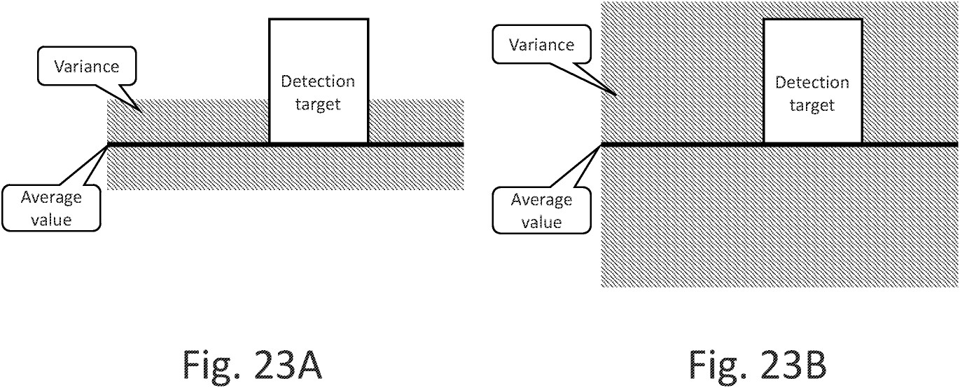

FIGS. 23A and 23B are conceptual diagrams for explaining how the accuracy of the road surface shape affects the object detection. In each figure, a horizontal line indicates an average value of the height of the ground, and a band around the horizontal line indicates variance in the height direction. Detection of a detection target indicated by a square using such a road surface shape map will be considered.

In the example shown in FIG. 23A, the height of the detection target is higher than the variance of the road surface shape. Therefore, even when the points of the LiDAR are removed based on the variance of the road surface shape, the points corresponding to the detection target remains, and thus the detection target can be detected. However, in the example shown in FIG. 23B, the detection target is buried in the variance of the road surface shape. When the points of the LiDAR are removed based on the variance of the road surface shape, the points of the LiDAR reflected from the detection target are also removed. That is, in the road surface shape map, it is assumed that the variance of the road surface shape in the height direction is smaller than the height of the detection target.

The following two factors are considered to increase the variance of the road surface shape in the height direction. The first factor is that unevenness (for example, a curb, a side ditch, grass unevenness, or the like) is actually present within the cells of the corresponding location. The second factor is that there is an error in the generation of the map data of the corresponding location. However, regardless of which factor is true, there is still a possibility that the recognition performance in the autonomous driving may be deteriorated as a result. Therefore, in the evaluation of the map data based on the road surface shape, the variance in the height direction of the road surface shape may be used as the evaluation value regardless of the factors.

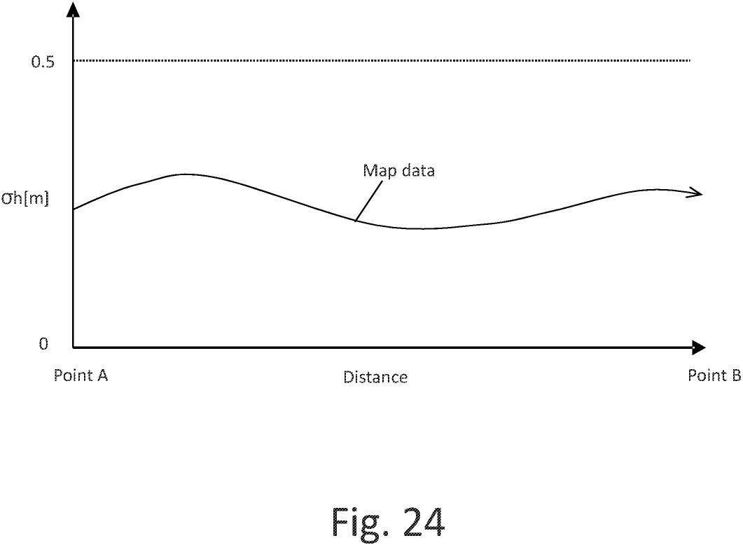

For example, it is assumed that the map data is generated using the log data acquired in the section from point A to point B. By plotting the variance σh in the height direction of the road surface shape of the map data on a graph in which the horizontal axis represents the distance from point A, the relationship between the variance σh and the distance as shown in FIG. 24 is obtained. The variance σh in the height direction of the road surface shape may be a variance in the height direction of a cell under the pose, that is, immediately below the vehicle, an average value of variances in the height direction of a plurality of cells around the vehicle, or a worst value of the variances of the plurality of cells around the vehicle.

If the variance in the height direction of the road surface shape map is associated with each pose, for example, the average value of the variances in the height direction of all poses from point A to point B can be used as the evaluation value. In addition, a median value of variance in the height direction of all poses from point A to point B may be used as the evaluation value. Furthermore, the worst value of the variance in the height direction of all poses from point A to point B may be used as the evaluation value.

### 5. Specific Example of Travel Plan Creation Processing

### 5-1. First Specific Example

The result of the evaluation of the map data performed as described above is associated with the map data for autonomous driving for each combination of conditions of parameters. The autonomous driving ECU 200 creates a travel plan by using the map data in which the evaluation value is associated with each combination of conditions of parameters. A concrete example of the travel plan creation processing by the autonomous driving ECU 200 will be described below.

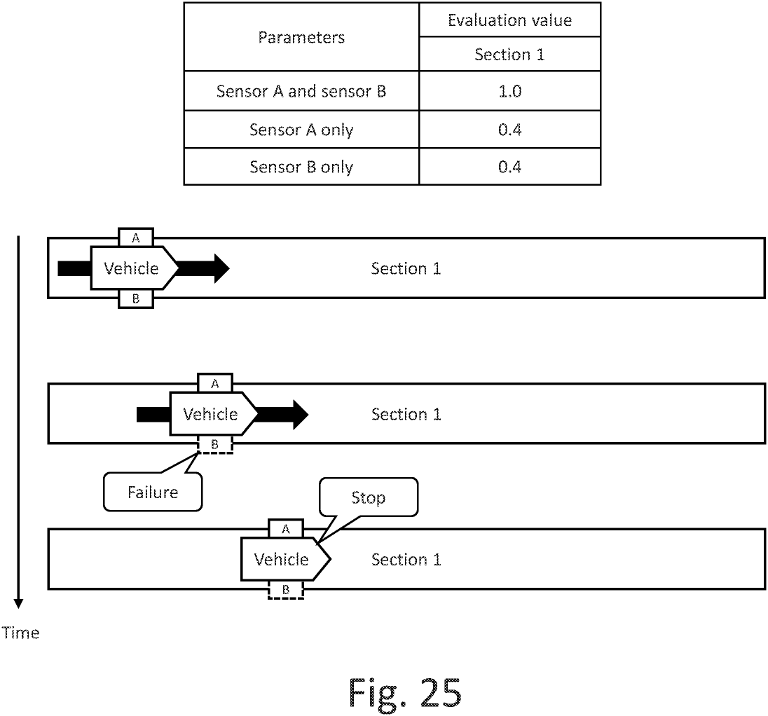

FIG. 25 is a conceptual diagram illustrating a first utilization example of an evaluation value in the creation of the travel plan. In the first application example, an evaluation value is set in map data for each combination of conditions of parameters for section 1 in which an autonomous driving vehicle (hereinafter simply referred to as a vehicle) travels. The vehicle is equipped with sensor A and sensor B, and the presence or absence of data of sensor A and the presence or absence of data of sensor B are parameters for determining the evaluation value. When there is data of sensor A and there is data of sensor B, the evaluation value is 1.0. When there is data of sensor A and there is no data of sensor B, the evaluation value is 0.4. When there is no data of sensor A and there is data of sensor B, the evaluation value is 0.4.

In the first utilization example, the evaluation value is used to select whether to continue or stop autonomous driving. For example, it is assumed that the evaluation value at which the autonomous driving can be continued is 0.5 or more. In this case, when both sensor A and sensor B are normal, the evaluation value of the parameter of the vehicle is 1.0, and thus the autonomous driving ECU 200 can cause the vehicle to travel in section 1 by autonomous driving. However, if sensor B fails for some reason while the vehicle is traveling in section 1, the evaluation value of the vehicle parameter decreases from 1.0 to 0.4. When the evaluation value becomes lower than 0.5, autonomous driving cannot be continued, and the autonomous driving ECU 200 stops the vehicle on the spot.

As a countermeasure after the automatic driving is stopped and the vehicle is stopped, switching to manual driving is performed if a person capable of driving is in the vehicle. It is also possible to request assistance from a remote operator using communication from a stopped state. Methods of assistance by the remote operator include sending an engineer to the site who is able to repair the vehicle, sending a driver to the site who is able to drive the vehicle, sending a wrecker to the site who is able to tow the vehicle to retrieve the vehicle, etc. In addition, when the vehicle has a remote operation function (including a remote driving function), the vehicle may be operated by remote operation by the remote operator.

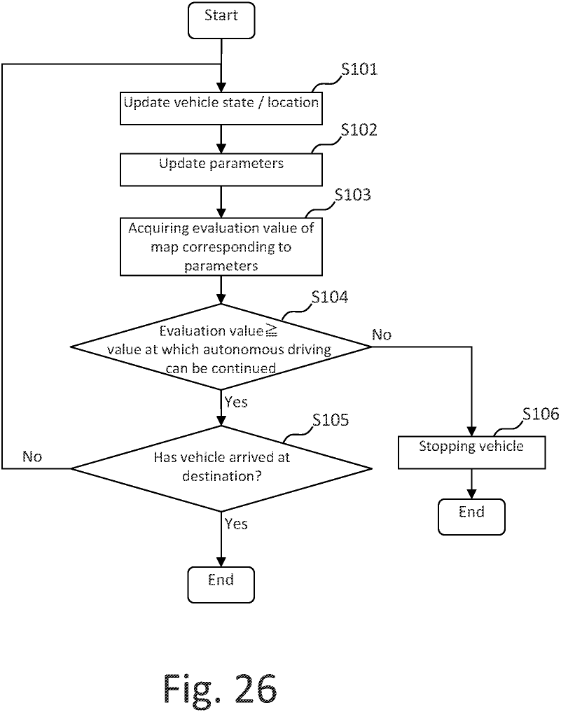

FIG. 26 is a flowchart showing the first specific example of processing for realizing the first utilization example described above, that is, travel plan creation processing. This processing is processing executed by the autonomous driving ECU 200 when the traveling plan creation program is executed by the processor 201.

In step S101, the vehicle state is updated based on the sensor data of the internal sensor 320. Further, the vehicle location is updated based on the vehicle location information received by the GPS receiver 310 and the map data stored in the map data DB 260.

In step S102, the parameters related to the automatic driving of the vehicle are updated based on the location information of the vehicle received by the GPS receiver 310 and the sensor information of the internal sensor 320 and the external sensor 330.

In step S103, the evaluation value of the map data corresponding to the parameters updated in step S102 is acquired from the map data DB 260. When the evaluation value is associated with the location, the evaluation value corresponding to the vehicle location updated in step S101 is acquired.

In step S104, it is determined whether or not the evaluation value acquired in step S103 is equal to or greater than a value at which autonomous driving can be continued. If the determination result is positive, the processing proceeds to step S105. If the determination result is negative, the processing proceeds to step S106.

In step S105, it is determined whether the vehicle has reached the destination. If the determination result is positive, the processing ends. If the determination result is negative, the processing returns to step S101.

In step S106, the vehicle is stopped on the spot. Then, after the vehicle is stopped, the processing ends.

### 5-2. Second Specific Example

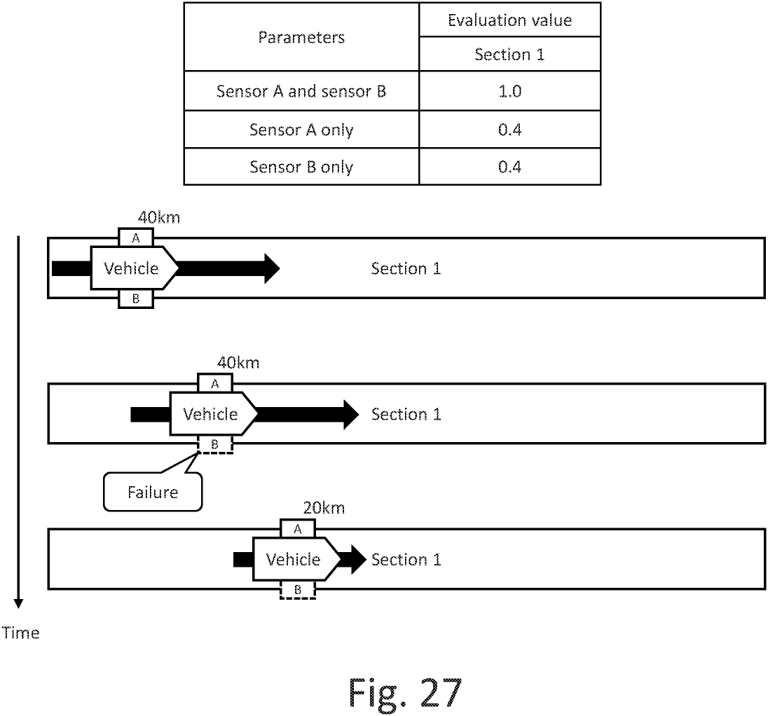

FIG. 27 is a conceptual diagram illustrating a second utilization example of an evaluation value in the creation of the travel plan. In the second utilization example, an evaluation value is set in the map data for each combination of conditions of parameters for section 1 in which the vehicle travels. The evaluation value set in the map data is the same as that in the first utilization example.

In the second utilization example, the evaluation value is used to select a travel mode. An example of the traveling mode is a speed during automatic driving. For example, it is assumed that the evaluation value at which autonomous driving can be continued at 40 km/h is 0.6 or more, and the evaluation value at which autonomous driving can be continued at 20 km/h is 0.4 or more. In this case, when both sensor A and sensor B are normal, since the evaluation value of the parameter of the vehicle is 1.0, the autonomous driving ECU 200 can cause the vehicle to travel in section 1 by autonomous driving of 40 km/h. However, if sensor B fails for some reason while the vehicle is traveling in section 1, the evaluation value of the vehicle parameter becomes lower than 0.6, and the automatic driving cannot be continued if the 40 km/h is maintained.

However, the evaluation value of the vehicle parameter in the state in which sensor B fails is 0.4. If the evaluation value is 0.4 or more, the automatic driving can be continued by reducing the speed to 20 km/h. The autonomous driving ECU 200 reduces the speed of the vehicle to 20 km/h to continue autonomous driving, and the vehicle passes through section 1 by autonomous driving.

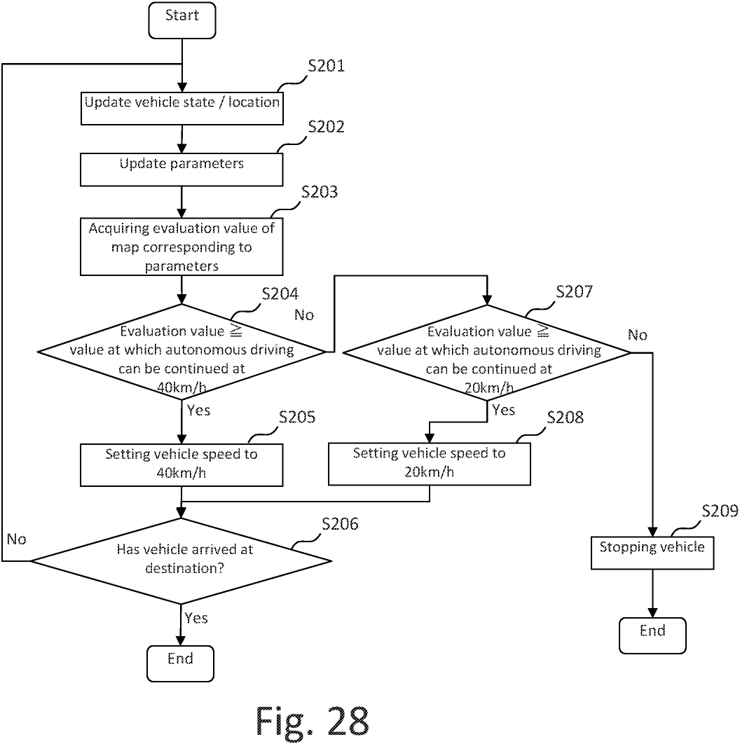

FIG. 28 is a flowchart showing a process for realizing the second utilization example described above, that is, the second specific example of the travel plan creation processing. This processing is processing executed by the autonomous driving ECU 200 when the traveling plan creation program is executed by the processor 201.

In step S201, the vehicle state is updated based on the sensor data of the internal sensor 320. Further, the vehicle location is updated based on the vehicle location information received by the GPS receiver 310 and the map data stored in the map data DB 260.

In step S202, the parameters related to the automatic driving of the vehicle are updated based on the location information of the vehicle received by the GPS receiver 310 and the sensor information of the internal sensor 320 and the external sensor 330.

In step S203, the evaluation value of the map data corresponding to the parameters updated in step S202 is acquired from the map data DB 260. When the evaluation value is associated with the location, the evaluation value corresponding to the vehicle location updated in step S201 is acquired.

In step S204, it is determined whether or not the evaluation value acquired in step S203 is equal to or greater than a value at which the automatic driving can be continued at 40 km/h. If the determination result is positive, the processing proceeds to step S205. If the determination result is negative, the processing proceeds to step S207.

In step S205, the vehicle speed is set to 40 km/h. After setting the vehicle speed, the processing proceeds to step S206.

In step S207, it is determined whether or not the evaluation value acquired in step S203 is equal to or greater than a value at which the automatic driving can be continued at 20 km/h. If the determination result is positive, the processing proceeds to step S208. If the determination result is negative, the processing proceeds to step S209.

In step S208, the vehicle speed is set to 20 km/h. After setting the vehicle speed, the processing proceeds to step S206.

In step S206, it is determined whether the vehicle has reached the destination. If the determination result is positive, the processing ends. If the determination result is negative, the processing returns to step S201.

In step S209, the vehicle is stopped on the spot. Then, after the vehicle is stopped, the processing ends.

### 5-3. Third Specific Example

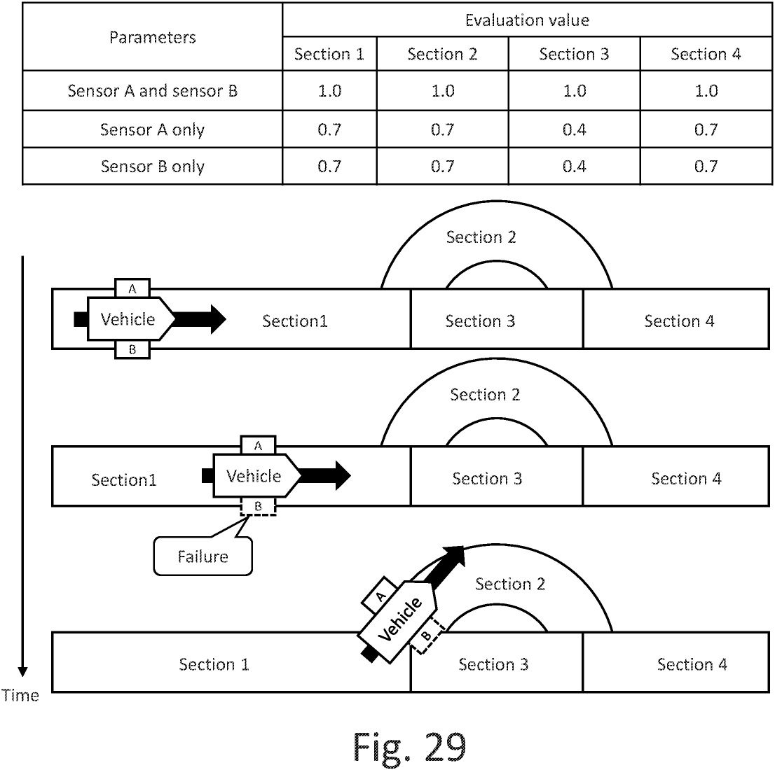

FIG. 29 is a conceptual diagram illustrating a third utilization example of an evaluation value in the creation of the travel plan. In the third utilization example, the section in which the vehicle travels is divided into four sections 1 to 4, and an evaluation value is set in the map data for each combination of conditions of parameters for each section. The evaluation value in the case where there is data of sensor A and there is data of sensor B is 1.0 in any of the sections 1 to 4. The evaluation value in the case where there is data of sensor A and there is no data of sensor B is 0.7 in section 1, 2, and 4 but 0.4 only in section 3. The evaluation value in the case where there is no data of sensor A and there is data of sensor B is 0.7 in section 1, 2, and 4, but 0.4 only in section 3. Here, the evaluation value at which autonomous driving can be continued is set to 0.5 or more.

In the third utilization example, the evaluation value is used to select a route. For example, it is assumed that the vehicle is about to travel on the shortest route from section 1 to section 4. When both sensor A and sensor B are normal, the evaluation value of the parameter of the vehicle is 1.0. Therefore, the autonomous driving ECU 200 can cause the vehicle to travel by autonomous driving on the shortest route from section 1 to section 4 via section 3. However, it is assumed that sensor B fails for some reason while the vehicle is traveling in section 1. Since the evaluation value of section 1 is 0.7 even if sensor B fails, the autonomous driving ECU 200 can cause the vehicle to continue autonomous driving while traveling in section 1.

However, in section 3, which is the shortest route, the evaluation value when sensor B is in failure is 0.4, which is lower than 0.5 at which automatic driving can be continued. That is, in a state where sensor B is in failure, the vehicle cannot pass through section 3 by automatic driving. On the other hand, when section 2 is selected, which detours around section 3, the evaluation value is maintained at 0.5 or more at which autonomous driving can be continued. In this case, the autonomous driving ECU 200 selects section 2 as the route, and causes the vehicle to go to section 4 via section 2.

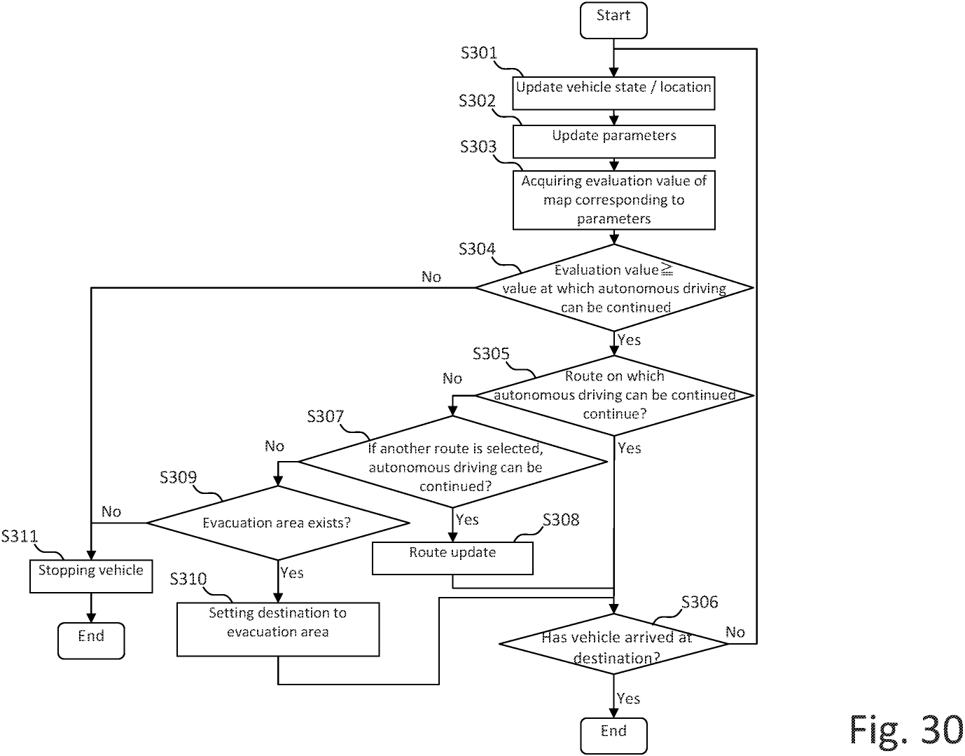

FIG. 30 is a flowchart showing processing for realizing the above-described third utilization example, that is, the third specific example of the travel plan creation processing. This processing is processing executed by the autonomous driving ECU 200 when the traveling plan creation program is executed by the processor 201.

In step S301, the vehicle state is updated based on the sensor data of the internal sensor 320. Further, the vehicle location is updated based on the vehicle location information received by the GPS receiver 310 and the map data stored in the map data DB 260.

In step S302, the parameters related to the automatic driving of the vehicle are updated based on the location information of the vehicle received by the GPS receiver 310 and the sensor information of the internal sensor 320 and the external sensor 330.

In step S303, the evaluation value of the map data corresponding to the parameters updated in step S302 is acquired from the map data DB 260. When the evaluation value is associated with the location, the evaluation value corresponding to the vehicle location updated in step S301 is acquired.

In step S304, it is determined whether or not the evaluation value acquired in step S303 is equal to or greater than a value at which autonomous driving can be continued. If the determination result is positive, the processing proceeds to step S305. If the determination result is negative, the processing proceeds to step S311.

In step S305, it is determined whether or not a route on which autonomous driving can be continued will continue from this point on the basis of the evaluation value of the forward route corresponding to the parameters updated in step S302. If the determination result is positive, the processing proceeds to step S306. If the determination result is negative, the processing proceeds to step S307.

In step S307, it is determined whether or not a route on which autonomous driving can be continued will continue if another route is selected, based on the evaluation value of another route corresponding to the parameters updated in step S302. If the determination result is positive, the processing proceeds to step S308. If the determination result is negative, the processing proceeds to step S309.

In step S308, the route to be traveled is updated from the initial route to the route selected in step S307. After updating the route, the processing proceeds to step S306.

In step S309, it is determined whether or not there is an evacuation area on the route on which autonomous driving can be continued. If the determination result is positive, the processing proceeds to step S310. If the determination result is negative, the processing proceeds to step S311.

In step S310, the destination is changed from the original point to the evacuation area. After the destination is changed, the processing proceeds to step S306.

In step S306, it is determined whether the vehicle has reached the destination. If the determination result is positive, the processing ends. If the determination result is negative, the processing returns to step S301.

In step S311, the vehicle is stopped on the spot. Then, after the vehicle is stopped, the processing ends.

### 6. Vehicle Control Using On-line Calculation of Evaluation Value

### 6-1. Online Calculation of Evaluation Value

As described above, the self-location estimation by SLAM is performed at the time of creating the map data. The SLAM requires large computational resources and is therefore computed off-line. However, if a particle filter is used instead of SLAM, self-localization can be performed online. Then, based on the result of the self-location estimation, it is possible to calculate a probability that estimation is successful, that is, a p-value as an evaluation value.

First, as step 1, points obtained from LiDAR is acquired. A point image is obtained by mapping the three-dimensional points obtained from the LiDAR onto a plane.

In step 2, features are detected from the points of the LiDAR. The point image is processed by a feature detector, and features are detected to obtain a feature image. It is preferable that the algorithm of feature detection used here is the same algorithm as the algorithm used when the feature map is generated.

In step 3, matching between the feature detected in step 2 and the feature map is performed. The amount of movement from the previously estimated self-location is estimated using locators (IMU and GPS). Then, matching is performed between the feature of the feature map around the estimated location where the ego-vehicle is currently located and the feature acquired in step 2. In on-line processing, the particle filter is used for matching for the self-location estimation.

In step 4, the self-location on the map is updated from the result of matching in step 3. After completion of step 4, from the updated self-location (pose) and the feature used for estimation of the self-location, the degree to which the self-location is likely to have succeeded in estimation is statistically obtained. The statistical probability obtained here is a p-value calculated on-line and is a p-value calculated off-line, that is, a numerical value having the same meaning as the degree of success of self-localization at a pose by SLAM.

### 6-2. Specific Example of Vehicle Control Based on Evaluation Value Calculated Online

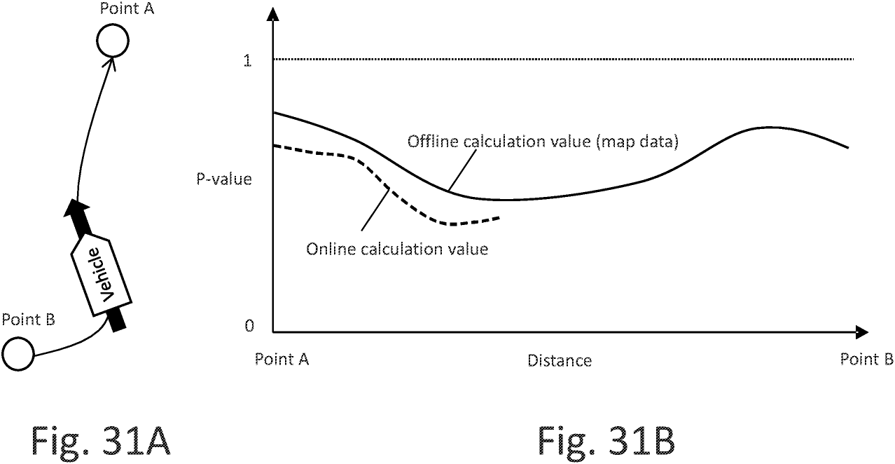

It is assumed that the vehicle is automatically driven from a point A to a point B on the map data in which the p-value as the evaluation value is written, as shown in FIG. 31A. Every time the self-location estimation is performed, the autonomous driving ECU 200 calculates the p-value at the location online. In FIG. 31B, the p-value on the map data calculated by the off-line calculation (here, SLAM) and the p-value of the current location calculated by the on-line calculation (here, particulate filter) are represented on the same graph.

In general, the accuracy of on-line calculation is lower than that of off-line calculation, and thus the p-value obtained by on-line calculation is lower than the p-value obtained by off-line calculation. However, when a state in which the p-value obtained by the on-line calculation is too low with respect to the p-value obtained by the off-line calculation continues, it can be determined that some abnormality has occurred. For example, when a state where the p-value obtained by the on-line calculation is lower than the p-value obtained by the off-line calculation by 0.2 or more continuously occurs for 1 second or more, it may be determined that an abnormality has occurred in the vehicle.

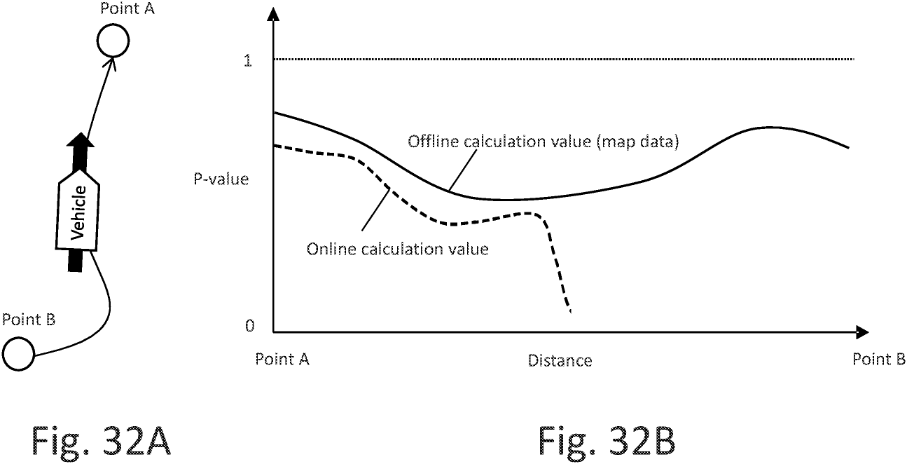

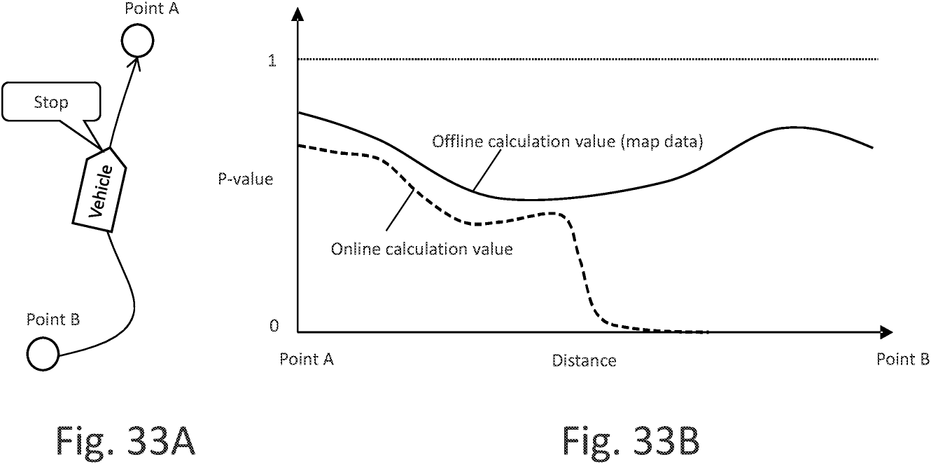

Here, it is assumed that the p-value obtained by the on-line calculation decreases as shown in FIG. 32A at the location of the vehicle shown in FIG. 32B, and a state where the p-value is lower than the p-value obtained by the off-line calculation by 0.2 or more continuously occurs for 1 second or more. In this case, the autonomous driving ECU 200 determines that the self-location estimation has failed, and stops the autonomous driving as shown in FIG. 33A. The p-value obtained by the on-line calculation is 0 in FIG. 33B because the automatic driving is stopped.

After the vehicle is stopped, the autonomous driving ECU 200 performs the self-location estimation again by expanding the matching range or the like, and investigates whether or not the p-value recovers to a value at which autonomous driving is possible. If a person capable of driving is present in the vehicle, automatic driving may be switched to manual driving. It is also possible to request assistance from a remote operator using communication from a stopped state.

### 7. Others

The map data evaluation processing by the map data generation device 100 can also be applied to a road surface luminance map. In each cell of the road surface luminance map, the number of points of the LiDAR reaching the cell and the average value and the variance of the road surface luminance are stored. In the calculation of the average value and the variance of the road surface luminance, the values (reflection intensities) of all the LiDAR’s points reaching the cell are used. In the calculation method of the evaluation value of the road surface shape map, by replacing the variance of the height in the road surface shape map with the variance of the road surface luminance in the road surface luminance map, the calculation method can be used as the calculation method of the evaluation value of the road surface luminance map.

What is claimed is:

1. A map data generation method comprising:
generating a plurality of data sets from a travel log data group, wherein
each of the plurality of data sets includes one or more travel log data, and
each travel log data included in the travel log data group is defined by one or more parameters;
generating map data for evaluation from each of the plurality of data sets;
calculating an evaluation value for each map data for evaluation generated from each of the plurality of data sets;
specifying, based on a correspondence relationship between each of the plurality of data sets and the evaluation value of each map data for evaluation, a relationship between a combination of conditions of the one or more parameters and the evaluation value; and
generating map data for autonomous driving in which the evaluation value is associated with each combination of conditions of the one or more parameters.

2. The map data generation method according to claim 1, wherein
the one or more parameters include a parameter representing an internal state of the autonomous driving vehicle.

3. The map data generation method according to claim 1, wherein
the one or more parameters include a parameter representing an external state of the autonomous driving vehicle.

4. The map data generation method according to claim 1, wherein
the calculating the evaluation value comprises calculating a relative evaluation value based on a relative evaluation between the map data for evaluation.

5. A map data generation apparatus comprising:
at least one processor; and
at least one program memory coupled to the at least one processor and storing a plurality of executable instructions,
the plurality of executable instructions causes the at least one processor to execute:
generating a plurality of data sets from a travel log data group, wherein
each of the plurality of data sets includes one or more travel log data, and
each travel log data included in the travel log data group is defined by one or more parameters;
generating map data for evaluation from each of the plurality of data sets;
calculating an evaluation value for each map data for evaluation generated from each of the plurality of data sets;
specifying, based on a correspondence relationship between each of the plurality of data sets and the evaluation value of each map data for evaluation, a relationship between a combination of conditions of the one or more parameters and the evaluation value; and
generating map data for autonomous driving in which the evaluation value is associated with each combination of conditions of the one or more parameters.

6. A non-transitory computer-readable storage medium storing a map data generation program for causing a computer to execute processing comprising:
generating a plurality of data sets from a travel log data group, wherein
each of the plurality of data sets includes one or more travel log data, and
each travel log data included in the travel log data group is defined by one or more parameters;
generating map data for evaluation from each of the plurality of data sets;
calculating an evaluation value for each map data for evaluation generated from each of the plurality of data sets;
specifying, based on a correspondence relationship between each of the plurality of data sets and the evaluation value of each map data for evaluation, a relationship between a combination of conditions of the one or more parameters and the evaluation value; and
generating map data for autonomous driving in which the evaluation value is associated with each combination of conditions of the one or more parameters.
